(19) United States
(12) Patent Application Publication
(10) Pub. No.: US 2005/0012593 A1
(43) Pub. Date: Jan. 20, 2005

(54) Ignition apparatus and method

(76) Inventors: Donald J. Harrod, Belgium, WI (US); Steven J. Dimig, Plymouth, WI (US); Alan J. Ritz, Brookfield, WI (US); William P. Schuster III, Germantown, WI (US); Erik Esser, Milwaukee, WI (US)

Correspondence Address: MICHAEL BEST & FRIEDRICH, LLP, 100 E WISCONSIN AVENUE, MILWAUKEE, WI, 53202, US

(21) Appl. No.: 10/821,635

(22) Filed: Apr. 9, 2004

Related U.S. Application Data
(60) Provisional application No. 60/462,257, filed on Apr. 11, 2003.

(51) Int. Cl. H04Q 1/00

(52) U.S. Cl. 340/5.72; 307/10.5

(57) ABSTRACT

In some embodiments of the present invention, a modular vehicle ignition system is disclosed that is capable of housing various components, such as a lock cylinder, a remote keyless entry (RKE) transceiver, a radio frequency identification (RFID) transceiver, an operator identification system, a steering column lock, an ignition switch, and the like. In some embodiments, one or more of these components is coupled to a circuit board that is coupled to the housing. Furthermore, one or more of these components can be networked to other electronic and electromagnetic systems of the vehicle.

### BACKGROUND OF THE INVENTION

With an ever-increasing array and complexity of security, access, and control systems available for vehicles, design issues and problems continue to arise with regard to the installation, control, operation, and management of system components. A significant factor in these issues and problems is the replacement of mechanical components with electromechanical and electrical system components. Each new system often requires one or more additional actuators and/or controllers, as well as associated wiring. Accordingly, vehicle assembly has become more time consuming and complicated.

In many vehicles, easily accessible locations (such as locations for vehicle ignitions) are becoming increasingly crowded with more electronic elements and structure for performing a variety of features and functions. Conventional vehicle ignitions can have a variety of components positioned adjacent an ignition housing. For example, a lock cylinder, a steering column lock, an ignition switch, and a Radio Frequency Identification (RFID) system can be located in various positions adjacent the steering column and ignition of a vehicle. A large amount of wiring is typically used to connect each of these components to other components of a vehicle security, access, and control system, thereby adding significant complexity to vehicle assembly and making ignition installation and related components costly, complex and burdensome.

### SUMMARY OF THE INVENTION

Some embodiments of the present invention provide a modular ignition assembly for a vehicle having at least one door and at least one system operable by a key, the modular ignition assembly comprising: a housing; a key reader located at least partially within the housing, the key reader comprising an antenna; an RFID receiver coupled to the antenna and adapted to receive RFID signals from the key via the antenna, the RFID signals comprising a code used for authorizing operation of at least one system of the vehicle; a processor coupled to the key reader to receive signals from the key reader responsive to RFID signals received by the RFID receiver; and an RKE receiver located within the housing and adapted to receive RKE signals transmitted to the modular ignition assembly to unlock at least one door of the vehicle; wherein the housing, key reader, antenna, and RFID receiver comprise an assembly configured for mounting in a vehicle as a single integral unit.

In some embodiments, a method of assembling a vehicle ignition and access assembly operable by a key is provided and comprises: providing a housing; coupling an antenna to an RFID receiver, the RFID receiver adapted to receive RFID signals from the key via the antenna, the RFID signals comprising a code used for authorizing operation of at least one system of the vehicle; installing a key reader at least partially within the housing, the key reader comprising the antenna and the RFID receiver; coupling the RFID receiver to a processor adapted to receive signals from the key reader responsive to RFID signals received by the RFID receiver; and installing an RKE receiver in the housing; wherein the housing, key reader, antenna, and RFID receiver comprise an assembly configured for mounting in a vehicle as a single integral unit.

Some embodiments of the present invention provide a modular ignition assembly for a vehicle having at least one door and at least one system operable by a key, the modular ignition assembly comprising: a circuit board; a key reader coupled to the circuit board, the key reader comprising an antenna; an RFID receiver coupled to the antenna and adapted to receive RFID signals from the key via the antenna, the RFID signals comprising a code used for authorizing operation of at least one system of the vehicle; a processor coupled to the key reader to receive signals from the key reader responsive to RFID signals received by the RFID receiver; and an RKE receiver coupled to the circuit board and adapted to receive RKE signals transmitted to the modular ignition assembly to unlock at least one door of the vehicle; wherein the circuit board, key reader, antenna, and RFID receiver comprise an assembly configured for mounting in a vehicle as a single integral unit.

In some embodiments, a method of assembling a vehicle ignition and access assembly operable by a key is provided, and comprises: providing a circuit board; coupling an antenna to an RFID receiver, the RFID receiver adapted to receive RFID signals from the key via the antenna, the RFID signals comprising a code used for authorizing operation of at least one system of the vehicle; coupling the antenna and RFID receiver to the circuit board; coupling the RFID receiver to a processor coupled to the circuit board and adapted to receive signals from the RFID receiver responsive to RFID signals received by the RFID receiver; and coupling an RKE receiver to the circuit board; wherein the circuit board, antenna, and RFID receiver comprise an assembly configured for mounting in a vehicle as a single integral unit.

Further aspects of the present invention, together with the organization and operation thereof, will become apparent from the following detailed description of the invention when taken in conjunction with the accompanying drawings.

### BRIEF DESCRIPTION OF THE DRAWINGS

The present invention is further described with reference to the accompanying drawings, which show various embodiments of the present invention. In the drawings, wherein like reference numeral indicate like parts:

FIG. 1 is a perspective view of a modular ignition unit according to an embodiment of the present invention, shown mounted on a steering column;

FIG. 2 is a perspective view of the modular ignition unit illustrated in FIG. 1;

FIG. 3 is an exploded perspective view of the modular ignition unit illustrated in FIG. 2;

FIG. 4 is a side view of the modular ignition unit illustrated in FIG. 2;

FIG. 5 is a bottom view of the modular ignition unit shown in FIG. 2;

FIG. 6 is a cross-sectional side view of the modular ignition unit shown in FIG. 2;

FIG. 7 is a perspective view of a modular ignition unit according to another embodiment of the present invention;

FIG. 8 is another perspective view of the modular ignition unit illustrated in FIG. 7; shown with some parts removed;

FIG. 9 is a perspective view of a modular ignition unit according to another embodiment of the present invention;

FIG. 10 is a perspective view of a modular ignition unit according to another embodiment of the present invention;

FIG. 11 is a perspective view of a modular ignition unit according to yet another embodiment of the present invention;

FIG. 12 is a perspective view of the modular ignition unit illustrated in FIG. 11, shown with the modular ignition unit housing removed;

FIG. 13 is another perspective view of the modular ignition unit illustrated in FIGS. 11 and 12, shown with parts removed to show various elements of the modular ignition unit; and

FIG. 14 is yet another perspective view of the modular ignition unit illustrated in FIGS. 11-13, shown with parts removed to show various elements of the modular ignition unit.

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings, and are not limited to physically contacting or connected elements.

### DETAILED DESCRIPTION

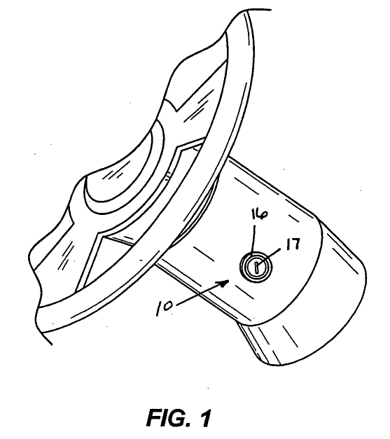

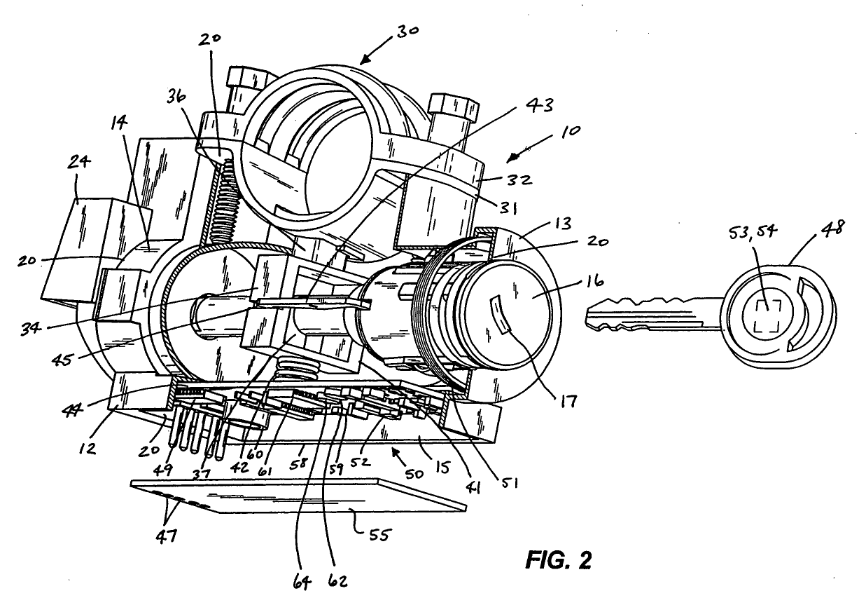

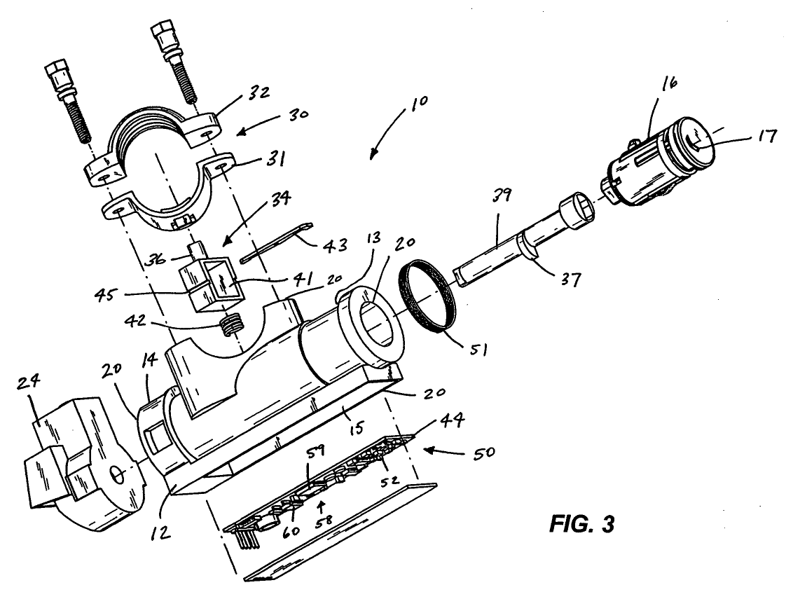

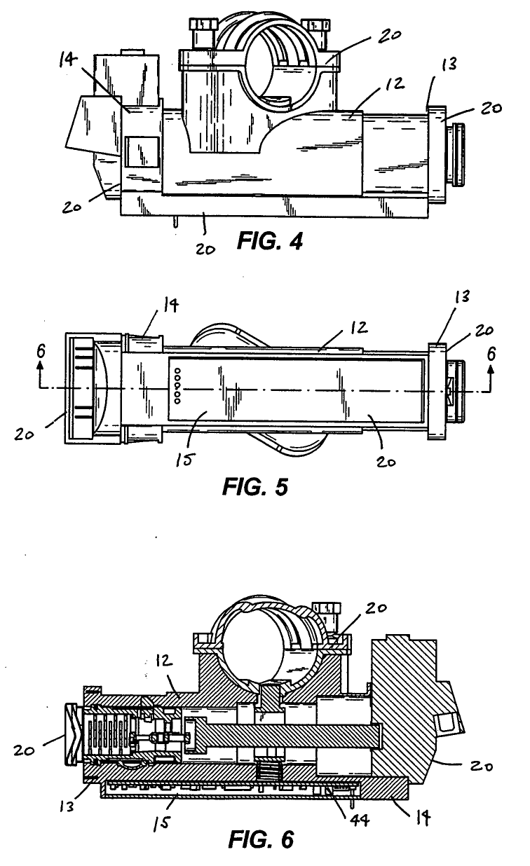

A modular ignition assembly 10 according to an embodiment of the present invention is illustrated in FIGS. 1-6. As shown in FIGS. 2 and 3, the modular ignition assembly 10 includes a housing 12 having a generally hollow and somewhat tubular shape, although other housing shapes can be used as desired. The housing 12 can include one or more connection locations 20 at which various assembly components can be coupled. As shown in FIGS. 1-6, these components include a lock cylinder 16, a Remote Keyless Entry (RKE) transceiver 59, a RFID transceiver 52, a steering column lock 34, and an ignition switch 24. The housing 12 can also have other components and combinations of components coupled thereto. Accordingly, the combination of components illustrated in FIGS. 1-6 is presented by way of example only.

As illustrated in FIGS. 2 and 3, the lock cylinder 16 is located within and coupled to a first end 13 of the housing 12. Alternatively, the lock cylinder 16 can be located in other positions and orientations in the housing 12, depending at least partially upon the shape of the housing 12 and the positions of the other components of the modular ignition assembly 10. Any type of lock cylinder 16 can be used in the modular ignition assembly 10. For example, the lock cylinder 16 can be a conventional lock cylinder having a mechanically coded tumbler assembly to prevent rotation of the lock cylinder 16 without insertion of an authorized key. In other embodiments, other types of key reading devices can be used as will be discussed in greater detail below.

In some embodiments, an ignition switch 24 is coupled to the housing 12. By way of example only, the ignition switch 24 can be located at an end 14 of the housing 12, and can be coupled to the housing 12 in an external location or can be received at least partially within the housing 12. The ignition switch 24 can be a conventional mechanical contact switch capable of carrying and controlling the distribution of power to components of the vehicle (including without limitation the engine, starter, and other vehicle accessories). As will be discussed in greater detail below, in some embodiments the ignition switch 24 is a solid state switch or includes one or more solid state components.

Other elements can also be included in or coupled to the housing 12. For example, as shown in FIGS. 2-6, the modular ignition assembly 10 can include a steering column lock 34. The steering column lock 34 can be externally coupled to the housing 12 or can be located partially or substantially entirely within the housing 12. For example, the modular ignition assembly 10 illustrated in FIGS. 1-6 has a steering column lock 34 located substantially within the housing 12 and includes a lock bolt 36 movable into and out of a position extended from the housing 12.

In some embodiments, a steering column collar 30 is also coupled to the housing 12. Alternatively, the housing 12 can include at least part of a steering column collar. For example, the steering column collar 30 shown in FIGS. 2-6 includes two collar elements 31, 32 attached to the housing 12 (such as by threaded fasteners as shown, by rivets, pins, clamps, or other fasteners, by snap fits, inter-engaging elements, adhesive or cohesive bonding material, by welding, brazing, or soldering, and the like). Alternatively, either or both collar elements 31, 32 can be part of the housing 12.

The steering column collar 30 can be used to mount the modular ignition assembly 10 to a conventional steering column shaft (not shown) of a vehicle and/or to orient the modular ignition assembly 10 with respect to the steering column shaft. Also, a steering column collar 30 can be used with or without a steering column lock 34.

The modular ignition assembly 10 can include any type of steering column lock 34. The steering column lock 34 shown in FIGS. 2-6 is a lock bolt-type steering column lock. The steering column lock 34 includes a lock bolt 36 that is at least partially housed within the housing 12 and is moveable between at least two positions to control movement of a steering column shaft. Although the lock bolt 36 shown in FIGS. 2-6 is at least partially located within the housing 12, in other embodiments, no portion of the lock bolt 36 is located within the housing 12. As shown in FIGS. 2-6, the lock bolt 36 extends through an aperture in the collar 30. In other embodiments, the lock bolt 36 extends through an aperture in other locations in the housing 12 in order to releasably engage a steering column shaft.

The lock bolt 36 can move in any manner into and out of engagement with a steering column shaft. For example, the lock bolt 36 shown in FIGS. 2-6 is translatable between a position in which the lock bolt 36 is extended toward the steering column shaft to lock the steering column (e.g., to releasably engage a channel or other aperture in the steering column shaft, or to otherwise limit rotation of any other element coupled to the steering column shaft) and a position in which the lock bolt 36 is retracted from the steering column shaft to unlock the steering column shaft. Although the lock bolt 36 shown in FIGS. 2-6 moves by translating between locked and unlocked positions, lock bolts in other embodiments can move in other manners, such as by pivoting, pivoting and translating, and the like.

In some embodiments, the lock bolt 36 is biased toward a locked or unlocked position by one or more biasing elements. For example, the lock bolt 36 shown in FIGS. 2-6 is biased by a compression spring 42 toward a locked position, although one or more extension springs, magnets, elastic elements, or other types of biasing element can instead be used for this purpose.

In some embodiments, the lock bolt 36 (or another element of the steering column lock 34 releasably engageable with the steering column) is movable by a cam 37 coupled to the lock cylinder 16. As shown in FIG. 3, the cam 37 is coupled to or integral with a pivot 39 extending from and drivable by the lock cylinder 16. The pivot 39 can also couple the lock cylinder 16 to the ignition switch 24. The pivot 39 and cam 37 are received within an aperture 41 in the lock bolt 36, and can be rotated by a mechanically coded key inserted within the lock cylinder 16.

The pivot 39 can be drivably coupled to the lock cylinder 16 in any manner desired, such as by a projection and aperture connection (e.g., see FIG. 3), by a threaded, welded, brazed, or soldered connection, by adhesive or cohesive bonding material, by one or more screws, bolts, rivets, and other conventional fasteners, and the like. Also, the cam 37 can be positioned in many different manners with respect to the lock bolt 36 in order to drive the lock bolt 36. For example, the cam 37 can be located within an aperture of the lock bolt 36 to cam against an internal surface of the aperture (e.g., see FIGS. 2 and 3), can be positioned to cam against a lip, ledge, post, boss, or other projection of the lock bolt 36, and the like.

In some embodiments, the lock bolt 36 (or other element of the steering column lock 34 releasably engageable with the steering column shaft) is actuated in other manners, such as by a gear on the pivot 39 driving teeth on the lock bolt 36, by one or more magnets coupled to the pivot or otherwise driven by the lock cylinder 16 to bias the lock bolt 36 in one or more directions, by a powered actuator positioned to drive the lock bolt 36 in one or more directions, and the like. Powered actuators can be used in many embodiments, such as in embodiments in which the lock cylinder or other key reader is not drivably coupled to the lock bolt 36. For example, some embodiments of the present invention (described below) use key readers that are not mechanically drivably connected to the steering column lock 34, ignition switch, and/or other elements of the modular ignition assembly 10. In these cases, a powered lock bolt actuator can be electrically coupled to actuate the steering column lock 34, such as to drive the lock bolt 36 toward locked and/or unlocked positions. Any type of powered actuator can be used for this purpose, including without limitation a solenoid, a motor, and the like.

Although a lock bolt-type steering column lock 34 is used in the illustrated embodiment of FIGS. 2-6, other elements and structures can be used for locking and unlocking a steering column shaft in other embodiments. In such cases, the steering column lock 34 can be placed in a locked state in which the steering column shaft is restrained from movement (or at least provides sufficient resistance to movement in order to disable the vehicle) and an unlocked state in which the vehicle can be steered. Elements and structures for performing this function include, without limitation, one or more straps, bands, or other elongated elements that can be tightened about the steering column shaft in a locked state and loosened in an unlocked state, one or more gears or toothed elements movable into and out of engagement with a gear or toothed element on the steering column shaft, one or more magnets (described below), and the like, any of which can be driven manually or by a powered actuator. Other types of steering column locks can be used in other embodiments of the modular ignition assembly 10 while still falling within the spirit and scope of the present invention.

In some embodiments, the lock bolt 36 (or other steering column lock element releasably engageable with the steering column shaft can be secured) in a position with respect to the steering column shaft. For example, if the lock bolt 36 is biased by a biasing element toward a locked position, the lock bolt 36 can be secured in an unlocked position until actuated to the locked position. The lock bolt 36 can be releasably secured in locked and/or unlocked positions in a number of different manners. For example, at least one pin, catch, arm or other lever, or other element can be actuated into and out of engagement with the lock bolt 36 in the unlocked position in order to releasably retain the lock bolt 36 in an unlocked position. As shown in FIGS. 2 and 3, an arm 43 extending from the lock cylinder 16 to the lock bolt 36 can be actuated by rotating, inserting or withdrawing a properly mechanically coded key within the lock cylinder 16 (e.g., such as by a camming motion against the key or a rotating cylinder portion). In various embodiments, rotation, insertion or withdrawal of a properly mechanically coded key within the lock cylinder 16 can move the arm 43 between two or more positions with respect to the lock bolt 36. For example, in some embodiments, withdrawing a key can cause the arm 43 to pivot to release the arm 43 from an aperture 45 in the lock bolt 36, releasing the lock bolt 36 to move to a locked position with respect to the steering column shaft (not shown). Although only one arm 43 is shown in FIGS. 2 and 3, two or more arms 43 or other elements can instead be actuated to perform similar functions. If desired, similar actuatable elements can be used to retain the lock bolt 36 in a locked position. As another example, the lock bolt 36 can be retained in locked and/or unlocked positions by one or more powered elements, such as an armature of a solenoid (or element coupled thereto) extended into interference with the lock bolt 36, one or more electromagnets selectively energized to retain the lock bolt 36 in a desired position, and the like.

As shown in FIGS. 2 and 3, the modular ignition assembly 10 can also include a circuit board 44. The circuit board 44 can be coupled to the housing 12 in any manner, such as by being mounted entirely or partially within the housing 12 or contiguous to the housing 12. As shown in FIGS. 2 and 3, the circuit board 44 is positioned within an opening 15 in housing 12, and can have one or more edges received within one or more slots 47 in the housing 12. The circuit board 44 can include a single or multiple circuit boards.

The circuit board 44 can operate one or more electrical and electromechanical devices of the modular ignition assembly 10. For example, the circuit board 44 can include a Remote Keyless Entry (“RKE”) receiver 59 for operating an RKE system 58 and a Radio Frequency Identification (“RFID”) receiver 52 for operating a system 50. Other embodiments of the circuit board include only a RFID system 50 or a RKE system 58/receiver 59.

The RFID receiver 52 can be adapted to receive one or more signals from a transmitter carried by a user, such as a transmitter in a key, key fob, card, or other portable user's device. The term “key” as used herein and in the appended claims refers to any portable device carried by a user and carrying a code used by a key reader to authenticate the portable device. For example, the term “key” includes any type of coded key surface mechanically read by a key reader, a key instead or additionally having any other type of coded surface read mechanically, optically, electronically, magnetically, or in any other manner, a key instead or additionally capable of sending one or more authorization signals to the modular ignition assembly by electrical connection or wireless transmission thereto, and the like. For example, the term “key” can include a key fob only.

The signal(s) from the key identify to the RFID receiver 52 that the user is authorized to operate the vehicle. In some embodiments, the circuit board 44 also has an RFID transmitter (not shown) that can communicate with a receiver also carried by the user in a key. In still other embodiments, the circuit board 44 has a RFID transceiver 52 in communication with a transceiver or with a transponder or “tag” of a key. For example, as shown in FIGS. 2 and 3, a RFID transceiver 52 is in communication with a tag 53 in a key 48. The tag 53 can be electronically programmed with a unique identifier transmitted to the transceiver 52 to identify the key 48 as an authorized key.

The RFID tag 53 can take any number of different shapes and sizes, and can be either active or passive. As is well known to those skilled in the art, an active RFID tag is powered by an internal battery and is capable of both reading and writing (i.e., tag data can be rewritten and/or modified). The battery-supplied power of an active tag typically gives it a longer read range. Passive RFID tags acquire operating power from the reader (which includes the RFID antenna 51 and transceiver 52 shown in FIGS. 2 and 3, as will be described in greater detail below). Passive tags typically operate based upon close proximity electromagnetic or inductive coupling. Because passive tags do not have a battery, they often have shorter read ranges than active tags and can require a higher-powered reader. As is well known in the art, some current passive tags can be read-only with a unique set of programmed data, can have a rolling code, can be designed with challenge-response data, and the like. However, other data configurations can be used with the present invention.

The RFID transceiver 52 shown in FIGS. 2 and 3 is part of a RFID system 50. In some embodiments, the RFID system 50 includes an antenna 51 electrically coupled to the RFID transceiver 54 (or receiver in some cases as described above), and can include a decoder for decoding signals received from the key 48. The antenna 51 can be directly or indirectly mounted to the circuit board 44. Also, the RFID system 50 can include another RFID antenna electrically coupled to the RFID tag 53 (or transmitter) of the key 48 for communication with the RFID transceiver 54.

The antenna 51 for the transceiver 52 can be housed in the housing 14. In some embodiments, the antenna 51 in the modular ignition assembly 10 emits radio signals to activate the transponder or tag 53 and to read and/or write data to it. The antenna 54 of the key 48 can be located adjacent the transponder 53. The antennas 51 and 54 provide for communication between the tag 53 and the transceiver 52, and can take a variety of shapes and sizes. The antenna 51 for the transceiver 52 can be located in many different areas. By way of example only, the antenna 51 can be molded in, mounted within, or mounted on the housing 12 of the modular ignition assembly 10 to receive tag data. As shown in FIGS. 2 and 3, the antenna 51 is molded into the front portion 13 of the housing 12 adjacent a key slot 17 of the lock cylinder 16. Tag data can be automatically received when the tag 53 is sufficiently close to the antenna 51 (such as in cases where the electromagnetic field produced by the antenna 51 is constantly present), can be received when the RFID system 50 is awakened by connection (e.g., physical insertion, withdrawal, or rotation of the key 48 in the lock cylinder 16) of the key 48 to the modular ignition system 10 or by one or more signals transmitted from the key 48 to the transceiver 52, or in other manners.

In some embodiments, a reader or interrogator for the RFID system 50 includes the antenna 51 packaged with the transceiver 52 (and decoder, if used). However, in some embodiments, the antenna 51 can be molded into the ignition housing 12 and can be coupled to the transceiver 52 upon assembly of the modular ignition assembly 10.

The transceiver 52 and antenna 51 can emit radio waves at any level of power desired in order to detect the presence of an authorized key. For example, in some embodiments, the transceiver 52 and antenna 51 emit radio waves effective for a relatively short distance (e.g., less than one foot, and in some cases, less than one inch). Depending at least in part upon the radio frequency used and the power output of the transceiver 52 and antenna 51, this distance can be as great as several hundred feet.

The RFID system 50 can operate at a wide range of frequencies. For example, the RFID system 50 can operate at a relatively low frequency (e.g., 30 KHz to 500 KHz), and can have a relatively short reading range while requiring fewer resources from the RFID system 50. As another example, the RFID system 50 can operate at a relatively high frequency (e.g., 850 MHz to 950 MHz and 2.4 GHz to 2.5 GHz), offering greater read ranges (greater than 90 feet) and relatively high reading speeds, while typically requiring greater system resources. Still other ranges of RFID operating frequencies can be used as desired.

In some embodiments, when a RFID tag (such as the tag 53 located in the key 48 or located in a card or fob) passes through an electromagnetic zone produced by the antenna 51 continually or periodically, the tag 53 can be activated by an activation signal transmitted by the antenna 51, and can respond by transmitting data to the transceiver 52 via the antennas 54, 51. The reader decodes the data encoded in the tag 53 (e.g., in the tag's integrated circuit in some embodiments), and the data is processed to determine if the tag 53 corresponds to an authorized key 48. In other embodiments, the transmission of data from the key 48 to the transceiver 52 can be initiated in any of the manners described above.

Once a signal is received by the RFID transceiver 52 indicating that the key 48 is an authorized key for the modular ignition assembly 10, a processor 49 on the circuit board 44 can take any number of actions, such as to activate one or more circuits on the circuit board 44, send signals to turn on, turn off, or change a state of one or more vehicle accessories (e.g., disable an alarm system, enable a starter circuit, and the like), or take other action(s). Locating the processor 49 on the circuit board 44 with the RFID transceiver 52 provides a modular RFID electronics package for the modular ignition assembly 10, in some cases simplifying installation of such electronics in a vehicle. In other embodiments, the processor 49 can be remote from the housing 12 and electrically coupled thereto in any manner.

Some embodiments of the modular ignition assembly 10 include a Remote Keyless Entry (RKE) system 58 on the circuit board 44. The RKE system 58 can have a receiver 59 adapted to receive one or more signals from a transmitter carried by a user, such as a transmitter in the key 48, or a transmitter in a key fob, card, or other portable user's device. The signal(s) identify to the RKE receiver 59 that the user is authorized to access the vehicle. In some embodiments, the circuit board 44 also has an RKE transmitter (not shown) that can communicate with a receiver also carried by the user (e.g., in the same key 48). In still other embodiments, the circuit board 44 has an RKE transceiver 59 in communication with a transponder or transceiver of the key. For example, as shown in FIGS. 2 and 3, an RKE transceiver 59 can receive signals from a transmitter (not shown) of the key 48.

In some embodiments, the RKE system 58 includes an antenna 60 electrically coupled to the RKE transceiver 59 (or receiver). The RKE antenna 60 can be directly or indirectly mounted to the circuit board 44. Also, the RKE system 58 can include another RKE antenna (not shown) electrically coupled to the transmitter (or transceiver) of the key 48 for communication with the RKE transceiver 59. In some embodiments in which the modular ignition system 10 includes an RFID system 50 and an RKE system 58, the same antenna can be used as the RFID and RKE antennas at the modular ignition assembly 10 and/or the same antenna can be used as the RFID and RKE antennas on the key.

The RKE antenna 60 electrically coupled to the RKE transceiver 59 can be in any of the locations referred to above with reference to the RFID antenna 60. Alternatively, the antenna 60 can be electrically coupled to the circuit board 44 and secured to a doorframe, the dashboard, under the hood, or in any other location in or on a vehicle.

In some embodiments, one or more signals can be sent from a transmitter on a key (e.g., a key fob) when a user depresses a button or other user-manipulatable control. Alternatively, in some embodiments in which the key has an RKE transponder (not shown), the RKE transponder can be activated by an activation signal transmitted by the RKE antenna 60, and can respond by transmitting data to the RKE transceiver 59.

The RKE signals transmitted from the key can be infrared, radio, or any other suitable type of communication signal. Each signal can contain an associated identification (“ID”) code. The ID code can represent a particular vehicle. The ID code can be a rolling code and/or an encrypted code. The ID code can be stored in the vehicle in order to enable authentication of transmitted signals.

The RKE system 58 can also include a controller 61, such as a microprocessor, microcomputer, or similar device. The controller 61 can operate to analyze RKE signals received from the key 48. In the controller 61 (or in a location accessible to the controller 61) can reside one or more memories or registers. The registers can contain the binary codes for one or more RKE action signals, functions, or commands (such as door lock, door unlock, trunk release, panic alarm activate, and other signals). In some embodiments, the registers can also include a vehicle-specific ID code. Accordingly, the RKE system 58 can be configured such that the ID code accessed by the controller 61 must match the ID code sent by the RKE transmitter on the key 48 in order for the RKE functions to be carried out. The controller 61 can be separate from a master vehicle control unit. However, in some embodiments, the controller 61 can be coupled to a master vehicle control unit or an engine control unit for the vehicle's electronic security and access system. Alternate vehicle controllers performing the functions described herein are also contemplated by the present invention.

In some embodiments, when a user depresses a user-manipulatable control on a key (e.g., a button or switch on a fob), the transmitter (not shown) of the key transmits a signal including a command and an ID code. The RKE signal can be received by the RKE antenna 60 and the transceiver 59. The RKE signal can be sent to a control unit for interrogation. In some embodiments, the control unit includes the controller 61 and an RKE processor, not shown. The controller 61 and/or the RKE processor can be located on the circuit board 44. In other embodiments, the controller 61 and/or the RKE processor are electrically coupled to the circuit board 44 but are remote from the housing 12. Locating the controller 61 and/or the RKE processor on the circuit board 44 with the RKE transceiver 59 provides a modular RKE electronics package for the modular ignition assembly 10, simplifying installation of such electronics in a vehicle.

In some embodiments, the RKE signal is analyzed to determine whether the ID code matches the vehicle's ID code and whether the command is a recognized command. If the ID code matches and the command is recognized, the command is implemented. However, if the ID code does not match, the command is not implemented, even if the command is recognized. Likewise, if the ID code matches, but the command is not recognized, the command is not implemented. The controller 61 and/or RKE processor can attempt to match the ID code first and then attempt to recognize the command, or vice versa.

The various components of the RFID and RKE systems 50, 58, as well as additional components, can be coupled to the housing 12 (either on, at least partially within, or within the housing 12) and/or can be formed integrally with the housing 12. For example, the circuit board 44 and antennas 51, 60 can be fastened to the housing 12 in any manner, such as by one or more rivets, pins, clamps, screws, bolts, or other fasteners, by snap fits, inter-engaging elements, or adhesive or cohesive bonding material, by crimping, welding, brazing, heat staking, potting, or soldering, by being received within grooves, recesses, or other apertures in the housing 12, and the like. In this regard, the type of material of which the housing 12 is made can have some bearing on the type of components used and the manner in which they are coupled to the housing 12. The circuit board 44 shown in FIGS. 2 and 3 received within one or more slots 47 in the housing 12, the RFID antenna 51 is molded into a portion of the housing 12, and the RKE antenna 60 is secured to the circuit board 44, although any other manners and combinations of manners to mount these components are possible and fall within the spirit and scope of the present invention. However, molding the RFID antenna 51 into or onto the housing 12 and securing the RKE antenna 60 to the circuit board 44 can reduce assembly and installation costs.

In some embodiments, the housing 12 is made of conventional materials, such as metal. However, in other embodiments, the housing 12 can be made partially or entirely out of plastic (e.g., a single-piece or multi-piece plastic body, a plastic body with integral or non-integral metal components, and the like) fiberglass, phenolic resin, or other synthetic or composite materials. The use of a plastic housing can reduce the cost and weight of the modular ignition assembly 10. Furthermore, the use of a plastic housing can allow certain elements to be molded into the housing 12, such as the RKE and/or RFID antennas 60, 51.

Plastic has not historically been used for ignition housings because plastic typically cannot resist the same magnitude of forces as other commonly used materials (e.g., aluminum, zinc, and steel). However, some embodiments of the present invention enable the housing 12 to be made of plastic.

As stated above, the type of material used for the housing 12 can affect the way in which components of the modular ignition assembly 10 are coupled to the housing 12. In other words, some housing materials better enable components of the modular ignition assembly 10 to be molded to the ignition housing 12 than others. By way of example only, by using a plastic housing 12, the RFID antenna 51 and/or RKE antenna 60 can be integrally molded within the housing 12, thereby reducing assembly time and cost. Various other objects can also be molded into the plastic housing 12, such as the circuit board 44, the ignition switch 24, the steering column collar 30, a guide for the steering column lock 34, various exterior components of the steering column lock 34, the lock cylinder 16, and the like. Other materials (e.g., composites, fiberglass, phenolic resins, ceramics, some metals, and the like) can also permit items to be molded into the housing 12.

The modular ignition assembly 10 shown in FIGS. 2-6 can operate as discussed in the following paragraphs. Assuming the user is outside of the vehicle and the vehicle is locked, the user can transmit a signal to the RKE transceiver 59 to unlock the doors of the vehicle. In some cases, the user depresses an unlock button or operates another type of user-manipulatable control on a key (e.g., a fob having one or more buttons). When the user presses the button, an unlock signal and ID code is transmitted by the transmitter. The RKE antenna 60 and the RKE transceiver 59 receive the signal and transmit the signal to the controller 61. In some embodiments, the signal is processed by the controller 61 in the modular ignition assembly 10, while in other embodiments, the signal is processed by a controller 61 outside of the modular ignition assembly 10. If the signal is processed by a controller located remote from the modular ignition assembly 10, data can be transferred between the remote controller and the transceiver 59 via a serial bus or a vehicle network.

If the ID code of the transmitted signal matches the vehicle's ID code, a door-unlocking device receives an unlocking signal from the controller 61. Accordingly, the door unlocking device (e.g., a solenoid, latch motor, or other actuator, not shown) can drive a door latch (also not shown) to an unlocked state. The user can then enter the vehicle.

Once the user enters the vehicle, the user can place the key 48 having a transponder 53 into the modular ignition assembly 10. In response to entry of the key 48 into the lock cylinder 16, the RFID transceiver 52 can transmit a signal via the RFID antenna 51 to activate and interrogate the transponder 53 in the key 48. The RFID transceiver 52 can be triggered to send out such an interrogation signal in a number of different ways. For example, the RFID transceiver 52 can constantly transmit an interrogation signal or can transmit an interrogation signal at timed intervals. In other embodiments, the RFID transceiver 52 can be triggered to transmit an interrogation signal for a period of time after a detected event (e.g., a door opening or closing, a vehicle lock changing states, and the like), after a sensor is tripped (such as a sensor detecting the presence of a person in the vehicle or a sensor detecting the presence of a key inserted in or coupled to the modular ignition assembly 10), and the like. In some embodiments, the RFID system can be in a “sleep mode” until triggered to activate. In those embodiments in which the RFID transceiver 52 is triggered by the key 48 being inserted in or coupled to the modular ignition assembly 10, the RFID system 50 can be triggered upon such insertion or connection or upon turning or other manipulation of the key 48.

Upon receipt of an interrogation signal from the RFID transceiver 52 and RFID antenna 51, the transponder 53 within the key 48 transmits an identification signal back to the RFID antenna 51 and RFID transceiver 52. If the identification signal received by the RFID transceiver 52 is correct, the processor 49 enables the vehicle to start. However, if the identification signal sent from the transponder 53 is incorrect, the vehicle will be inoperable. The vehicle can be made inoperable by not enabling at least one of many systems or devices of the vehicle, such as those discussed below, or by disabling at least one of many systems or devices of the vehicle.

In some embodiments, one or more systems or devices must be enabled for the vehicle to start. Thus, if the correct identification signal is received by the RFID transceiver 52, the various system(s) and/or device(s) can be enabled. However, if the correct identification signal is not received, the various system(s) and/or device(s) will not be enabled. In these and other embodiments, all systems and devices can be initially enabled, in which case receipt of an incorrect identification signal can disable one or more systems and devices of the vehicle. Some systems that can be enabled or disabled include the fuel system, the spark system, the starter system, and the like. With respect to the fuel system, devices such as the fuel pump can be enabled or disabled as appropriate to make the vehicle operable or inoperable. For example, in those embodiments that require the fuel system to be enabled, devices such as the fuel pump can be disabled until the proper signal is received from the RFID transponder 53, or can be enabled until an improper signal is received from the RFID transponder 53. With respect to the spark system, the spark plugs of the vehicle can be prevented from emitting a spark until a proper signal is received from the RFID transponder 53, or can be enabled until an improper signal is received from the RFID transponder 53. Additionally, with respect to the starter system, the starter motor or ignition switch 24 can be disabled until the proper signal is received from the RFID transponder 53 or can be enabled until an improper signal is received from the RFID transponder 53. In these and other embodiments, the lock cylinder 16 can be prevented from rotating (as described in greater detail below) or can otherwise be disabled if the correct identification signal is not received from the RFID transponder 53.

In some embodiments, as an additional security feature, the lock cylinder 16 can include a plurality of coded tumblers. The blade of the key 48 can include a mechanically coded surface that engages the tumblers. In a manner well known to those skilled in the art, if the mechanical code on the key blade matches the mechanical code of the tumblers, the lock cylinder 16 can be rotated upon insertion of the key blade, thereby permitting the lock cylinder 16 to operate the ignition switch 24.

Assuming that the key 48 is properly mechanically and/or electrically coded, the key 48 can be rotated to unlock the steering column lock 34. The steering column lock 34 can take any form, and can be manually actuated (i.e., under force from a user, such as by turning the key 48 in the lock cylinder 16) or can be powered.

By using a mechanical tumbler-type lock cylinder 16 in conjunction with an RFID system 50 as described above, two levels of system operation security are offered by the modular ignition assembly 10. However, other embodiments of the present invention do not use both security features, and instead use either the mechanical tumbler-type lock cylinder 16 or the RFID system 50.

In addition to unlocking the steering column lock 34, rotation of the key 48 in the lock cylinder 16 can also actuate the ignition switch 24 in a conventional manner. The ignition switch 24 can be actuated by the pivot 39 extending from the lock cylinder 16 to the ignition switch 24, and the ignition switch 24 can be rotated by the rotation of the lock cylinder 16. Accordingly, rotation of the lock cylinder 16 can control electrical contact positions of the ignition switch 24. Actuation of the ignition switch 24 to at least one contact position allows current to pass to the starter of the vehicle, thereby permitting the vehicle to be started and operated (assuming no vehicle devices and systems necessary for vehicle operation are disabled as described above).

Although the modular ignition lock assembly 10 described above and with reference to FIGS. 1-6 includes the various components discussed, it should be noted that not all components are needed or desirable in all embodiments of the present invention. For example, the RKE transceiver 59 can be located in other areas of the vehicle, and need not necessarily be located on the circuit board 44 or coupled to the housing 12 of the modular ignition assembly 10. Additionally, some embodiments may not use an RFID system 50. In those embodiments that do, any part of the RFID system 50 (e.g., the antenna 51, the RFID transceiver 52, and the like) can be located off the circuit board 44, and need not necessarily be coupled to the housing 12. As another example, in some embodiments the steering column lock 34 can be located remotely from the housing 12. Finally, other components not discussed herein, but understood by a person having ordinary skill in the art, can be included as components to the modular ignition assembly 10.

However, in some embodiments, each of the components and systems described above can be included in the modular ignition assembly 10. For example, RFID and RKE electronics can both be located on the circuit board 44, thereby lowering manufacturing costs, easing assembly of the electronics for both systems, and simplifying installation of the electronics in the modular ignition assembly 10. Locating RFID and RKE electronics on the circuit board 44 can also help to enclose such electronics in a common electronics enclosure, such as the space between the circuit board 44, a housing cover 55 (as shown in FIGS. 2, 3, and 5), and the walls of the housing 12. Also, by including the RFID and RKE electronics on the same circuit board 44, the number and locations of electrical connections to the modular ignition assembly 10 can be reduced. In some embodiments, a circuit board 44 having RFID and RKE electronics thereon can enable the modular ignition assembly 10 to be installed in the vehicle as a single integral unit, a feature that increases the modularity of the modular ignition assembly 10 and can reduce installation time and cost for RFID, RKE, and ignition systems.

As shown in FIGS. 2 and 3, the key cylinder 10, RFID electronics, and RKE electronics are located within or on the same housing 12, in some cases with the ignition switch 24 and/or steering column lock 34 located in or on the housing 12. Although not required, this arrangement of assembly components can also provide significant advantages in some embodiments. For example, locating the key cylinder 10, RFID electronics, and RKE electronics in or on the same housing 12 provides an assembly 10 having increased modularity, simplifying installation in a vehicle and reducing the time necessary for mounting separate parts and components in the vehicle. Including the ignition switch 24 and/or steering column lock 34 within the housing 12 provides similar benefits. In addition, a modular package having these components on or in a common housing 12 can reduce the amount of space taken by these components and can reduce the amount of and/or simplify the wiring connections needed for these components.

In some embodiments, the modular ignition assembly 10 can include additional electronics for receiving one or more signals from one or more tire pressure monitors on the vehicle. A tire pressure monitor receiver 62 can be mounted on the circuit board 44 and can be located within the housing 12 (although other locations for the tire pressure monitor receiver 62 are possible). The tire pressure monitor receiver 62 can be coupled to the RKE antenna 60 for receiving wireless signals from one or more conventional tire pressure monitors. In other embodiments, the tire pressure monitor receiver 62 can be coupled to another antenna mounted on the circuit board 44 and/or located in the housing 12. The tire pressure monitor receiver 62 can include or be connected to a processor for performing acts responsive to signals received from the tire pressure monitors. For example, the processor can send tire pressure levels to a display on the vehicle, can alert a user when a low tire pressure level has been reached, and the like. Although the modular ignition assembly 10 can receive wireless tire pressure monitor signals, in other embodiments, such signals can be received by wired electrical connections between the tire pressure monitors and the processor.

Some embodiments can include remote start electronics for receiving one or more signals from a key to start the vehicle. As shown in FIG. 2, a remote start receiver 63 can be mounted on the circuit board 44 and can be located within the housing 12 (although other locations for the remote start receiver 63 are possible). The remote start receiver 63 can be coupled to the RKE antenna 60 for receiving wireless signals from a key to start the vehicle. In other embodiments, the remote start receiver 63 can be coupled to another antenna mounted on the circuit board and/or located in the housing 12. The remote start receiver 63 can include or be connected to a processor for activating the vehicle's starter responsive to a corresponding signal received from a key. As shown in FIG. 2, the remote start receiver 63 can be electrically coupled to the processor 49, which can operate the vehicle starter system.

The modular ignition assembly 10 can include additional electronics for receiving one or more window control signals from a key, from vehicle door latch electronics, and/or from vehicle door lock electronics. As shown in FIG. 2, a window control receiver 64 can be mounted on the circuit board 44 and can be located within the housing 12 (although other locations for the window control receiver 64 are possible). The window control receiver 64 can be coupled to the RKE antenna 60 for receiving wireless signals from a key to raise, lower, and/or lock one or more vehicle windows. In other embodiments, the window control receiver 64 can be coupled to another antenna mounted on the circuit board and/or located in the housing 12. The window control receiver 64 can also include or be connected to a processor for controlling one or more vehicle windows responsive to signals received from electronics of one or more vehicle door latches or door locks. As shown in FIG. 2, the window control receiver 64 can be electrically coupled to the processor 49, which can operate the vehicle window(s). Although the modular ignition assembly 10 can receive wireless vehicle window control signals, in other embodiments, such signals can be received by wired electrical connections to the processor 49.

The tire pressure, remote start, and/or window control electronics can be included with or without the RKE and/or RFID electronics to provide a number of different combinations of features within the modular ignition assembly 10. By including the electronics of one or more of these additional systems on the circuit board 44, manufacturing costs can be significantly reduced, assembly can be simplified, and installation time and costs for such systems can be reduced. Also, by locating the electronics of any one or more of these additional systems on the circuit board 44, such electronics can be more readily located within a common electrical enclosure (such as the space between the circuit board 44, the housing cover 55 shown in FIGS. 2, 3, and 5, and the walls of the housing 12). Furthermore, by including the electronics of one or more of these additional systems on the same circuit board 44, the number and locations of electrical connections needed for these systems and the modular ignition assembly 10 can be reduced. In some embodiments, one or more circuit boards in addition to the circuit board 44 having such additional electronics can be included in the modular ignition assembly 10.

The tire pressure, remote start, and window control electronics can be located within or on the same housing 12, in some cases with the ignition switch 24 and/or steering column lock 34 also located within or on the housing 12. Although not required, any combination of these electronics in or on the housing 12 can also provide significant advantages, whether or not used in conjunction with the RFID and/or RKE electronics. For example, locating the lock cylinder 16 and RFID electronics in or on the same housing 12 as the tire pressure, remote start, and/or window control electronics can provide a modular ignition assembly 10 having increased modularity, simplifying installation in a vehicle and reducing the time necessary for mounting separate parts and components in the vehicle. In addition, a modular package having these components on or in a common housing 12 can reduce the amount of space taken by these components and can reduce and/or simplify the amount of wiring connections needed for these components.

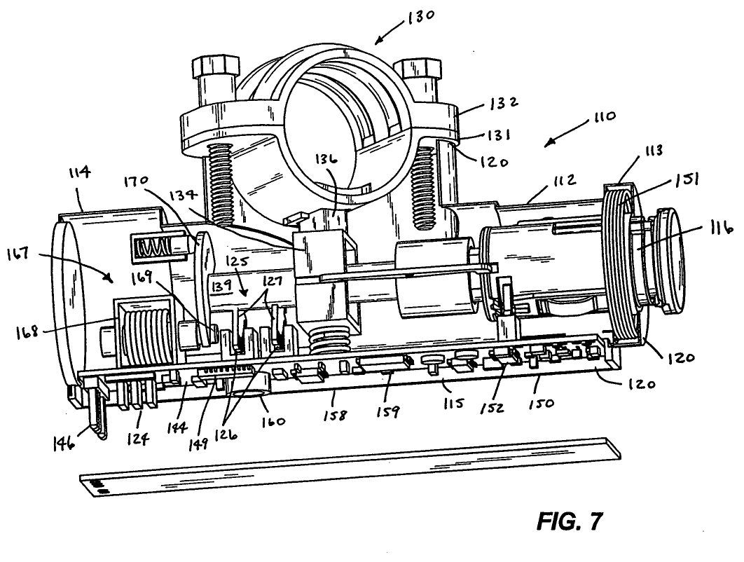

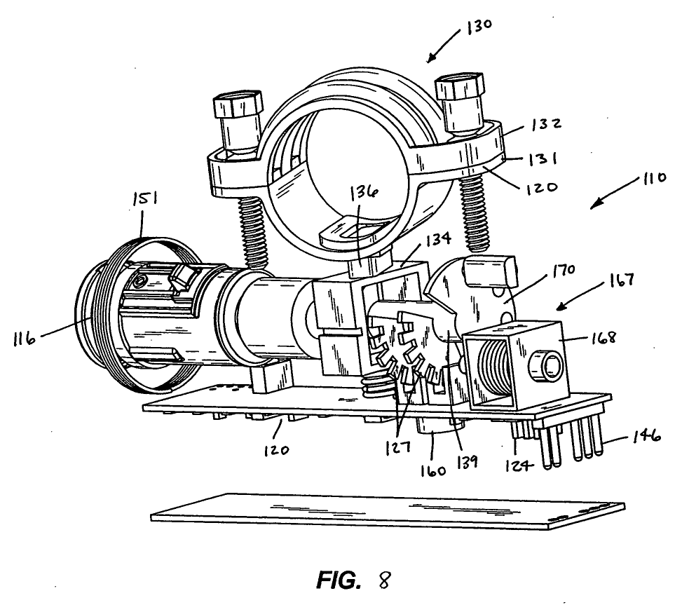

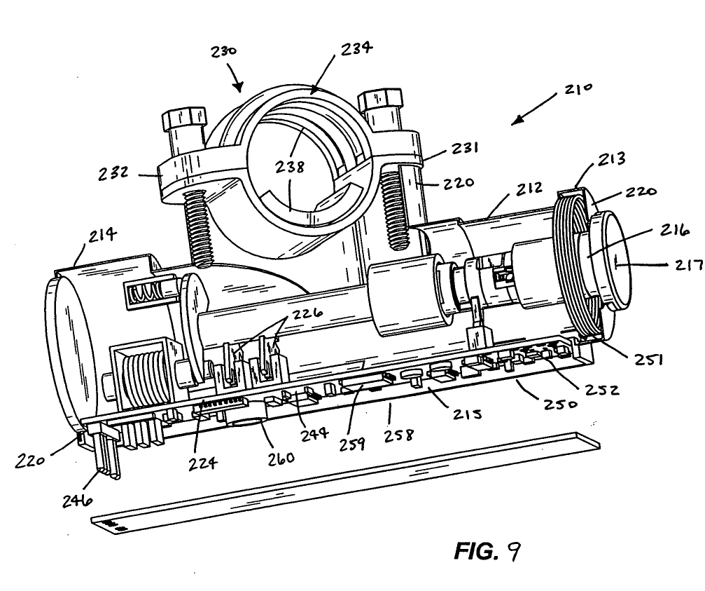

FIGS. 7 and 8 illustrate another embodiment of a modular ignition assembly. Elements and features of the embodiment shown in FIGS. 7 and 8 that correspond to elements and features of the embodiment of FIGS. 1-6 are designated hereinafter in the 100 series of reference numbers.

As shown in FIG. 7, a modular ignition assembly 10 can include a housing 112 with a plurality of connection locations 120 at which various components of the modular ignition 110 can be coupled. For example, the housing 112 can include a lock cylinder 116, an RKE transceiver 159, a RFID transceiver 152, a steering column lock 134, an ignition switch 124, and various other components.

The modular ignition assembly 110 can also include a circuit board 144 with various control systems, such as an RKE transceiver 159 and/or an RFID transceiver 152. However, unlike the modular ignition assembly 10, the circuit board 144 can include a solid state ignition switch 124 (or ignition switch comprising solid state components) mounted thereon or directly coupled thereto. In some embodiments, the solid state ignition switch 124 is located inside or on the housing 112.

The use of a solid state ignition switch 124 provides another level of protection to the modular ignition assembly 110 in that its operation is data driven. In other words, in some embodiments, the solid state ignition switch 124 cannot be overridden by “spiking” or “hot-wiring” the electrical connections to the modular ignition assembly 110, nor can the ignition switch 124 be mechanically forced to a vehicle-operative state.

In some embodiments, the solid state ignition switch 124 can receive inputs or data signals directly or indirectly from a controller or master controller in communication with the RFID transceiver 152. For example, in some embodiments, the ignition switch 124 can receive signals from one or more sensors of the modular ignition assembly 110. Such sensors include, without limitation, Hall effect sensors and other magnetic sensors, optical sensors, contact switches (e.g., microswitches, limit switches, and the like), and the like. Any of such sensors can be triggered by the insertion, withdrawal and/or turning of a key within the lock cylinder 116. The sensors can then output one or more signals to the controller/master controller or directly to the ignition switch 124 corresponding to the position of the key and the lock cylinder 116. Upon receipt of one or more predefined signals, the solid state ignition switch 124 can send one or more outputs to a controller (such as via a serial bus or vehicle network, in some embodiments) to activate various systems and devices of the vehicle. For example, the solid state ignition switch 124 illustrated in FIGS. 7-8 sends one or more outputs to a processor 149 located on the circuit board 144 and inside the housing 112 (although other locations of the processor 149 are possible). These outputs can be signals corresponding to the position of the lock cylinder 116, such as “RUN,” “ACCESSORY,” “START,” “OFF,” and the like. The controller to which these signals are sent and/or which processes the RFID signals can be a processor, discrete logic elements, other electronic circuitry, or combinations of these elements suitable for processing data signals received from the transceiver 152, sensors, or the ignition switch 124. The controller can be located on the circuit board 144 or remote from the modular ignition assembly 110 (e.g., via a data bus as described below or any other communications link).

The ignition switch 124 can take a number of different forms comprising solid state electronics. As shown in FIGS. 7 and 8, the ignition switch 124 can include a rotary encoder 125. Although any suitable rotary encoder can be used, the ignition switch 124 shown in FIGS. 7 and 8 includes a quadrature rotary encoder 125, and includes two members 127 rotatable to different positions with respect to two photo interrupters 126. The photo interrupters 126 can each include a light emitting diode (LED) and a photodetector positioned to detect a beam of light emitted by the LED, as is well known to those skilled in the art. In some embodiments, the photo interrupters can be Panasonic model number CNA1301H photo interrupters, although any other suitable photo interrupter can be used.

In some embodiments, the members 127 are round or are sector shaped (as shown in FIGS. 7 and 8), but can have any other shape capable of being rotated into a beam-interrupting position with respect to the photo interrupters 126. The members 127 can be apertured to selectively interrupt the light beams of the photo interrupters 126 when in different rotational positions. For example, the members 127 can include teeth on peripheral edges of the members 127, apertures of any shape located in any other positions on the members 127, and the like.

As shown in FIGS. 7 and 8, the members 127 are coupled to the lock cylinder 116 so that they rotate when a properly mechanically coded key is inserted and turned within the lock cylinder 116. The members 127 can be located on a pivot 139 extending from the lock cylinder 116 to a location adjacent the photo interrupters 126. In other embodiments, the members 127 can be coupled for rotation with the lock cylinder 116 in any other manner, and/or can be rotated upon insertion of a properly mechanically coded key into the lock cylinder 116. Although a mechanical connection between the lock cylinder 116 and the members 127 can be used to drive the members 127 to their different rotational positions, in other embodiments, the members 127 can be driven in other manners, such as by a motor on or connected to the circuit board 144 and driving a pivot upon which the members 127 are mounted. Such other manners of driving the members 127 can be used in embodiments in which no direct mechanical connection exists between the lock cylinder 116 and the members 127, no rotational force is otherwise required by a user in changing the states of the modular ignition system 110 using a key, and/or another type of key reader does not rotate to read keys. Examples of such alternate key readers are described in greater detail below.

Referring to FIGS. 7 and 8, as the members 127 of the rotary encoder 125 are rotated, the teeth of the members 127 pass through the light beam generated by each photo interrupter 126. The members 127 can be positioned with respect to one another such that different combinations of interrupted and non-interrupted states of the light beams are generated at different rotational positions of the rotary encoder, thereby defining different states of the rotary encoder 125.

By counting the number of teeth passing each light beam, the processor 149 receiving signals from the photo interrupters 126 can determine the rotary position of the members 127 (and therefore, of the key). This process can be used to detect any number of rotary positions or ranges of rotary positions, as opposed to only detecting the binary states of the photo interrupters 126. Such a quadrature-type rotary encoder can therefore be used to detect additional states of the ignition switch 124 without the need for additional sensors, and can directly or indirectly control any number of devices (e.g., some two-way devices, such as remote starters).

In other embodiments, the number of teeth passing each light beam is not counted. Instead, the two photo interrupters 126 send signals to the processor 149, which is therefore able to detect four states of the rotary encoder 125. The four states of the rotary encoder 125 can represent four positions (or ranges of positions) of the lock cylinder 116 and four corresponding states of the ignition switch 124. For example, the four states can correspond to “OFF”, “ACCESSORY”, “RUN”, and “START” states of the ignition switch 124. In some embodiments, one or more additional photo interrupters and corresponding members can be used to detect additional states of the ignition switch 124.

As shown in FIGS. 7 and 8, the modular ignition assembly 110 can also include a park interlock assembly 167 for preventing a user from placing the modular ignition assembly 110 in one or more states (e.g., an off state) before the vehicle has been placed in park. In some embodiments, the modular ignition assembly 110 can prevent a user from turning a key in the lock cylinder 116 to turn the vehicle off until the vehicle is in park. The park interlock assembly 167 can be used in any of the modular ignition assemblies disclosed herein, and is shown in the embodiment of FIGS. 7 and 8 by way of example only. In some embodiments, the modular ignition assembly 110 can allow a user to turn a key in the lock cylinder 116 and turn the vehicle off, but can prevent the user from withdrawing a key from the lock cylinder 116 until the vehicle is in park. Information regarding whether the vehicle is in park can be transmitted via a serial bus or vehicle network to the modular ignition assembly 110 from an appropriate controller within the vehicle.

The park interlock assembly 167 shown in FIGS. 7 and 8 includes a solenoid 168 mounted to the circuit board 144, and positioned to move an armature 169 into and out of a position with respect to a stop 170 coupled to the pivot 139. When the armature 169 is placed in an extended position by the solenoid 169, the stop 170 prevents rotation of the pivot 139 to an off position. When the armature 169 is retracted by the solenoid 169, the pivot 139 is free to rotate to the off position. Although the stop 170 is shown as having a sector shape, the stop 170 can take any suitable shape, including without limitation a pin, flange, boss, or other element extending from the pivot 139. Also, in other embodiments, the stop 170 can be mechanically coupled for rotation with the lock cylinder 116 in any other suitable manner.

Other types of elements can be used to limit rotation of the pivot 139. For example, a lever can be movable into and out of engagement with a stop that is on or part of the pivot 139. As another example, a gear can be moved into and out of engagement with teeth or a gear on the pivot 139, or can be selectively prevented from rotation in any manner in order to prevent the pivot 139 from moving to a position (e.g., an off position). Also, any conventional park interlock assembly can be used to selectively limit the amount of rotation of the pivot 139.

Still other embodiments can use non-mechanical park interlocks. For example, a processor (whether or not mounted on the circuit board 144) can receive one or more signals from a sensor detecting whether the vehicle is in park, and can prevent the modular ignition assembly 110 from being placed in an off state until such a signal(s) are received. In some embodiments, the park sensor signal(s) can be received from a serial bus or vehicle network.

In general the modular ignition assembly 110 (and the circuit board 144) can be connected to a serial bus or vehicle network in order to provide information to and receive information from other electronic components within the vehicle in a prescribed manner. The serial bus or vehicle network can be any suitable, conventional serial bus or network configuration typically used in vehicle control systems. Typically, packets of information from the modular ignition assembly 110 can be provided to the serial bus and other electronic components connected to the serial bus can poll the serial bus for certain types of information. For example, the modular ignition assembly 110 can provide position information for the lock cylinder 116 to the serial bus and the vehicle's appropriate controller(s) can poll the serial bus for position information. As a result, the vehicle's appropriate controller(s) will receive the position information whenever it is provided to the serial bus by the modular ignition assembly 110.

In addition to position information, RKE information and RFID information can be provided to the serial bus by the modular ignition assembly 110 for use by other electronic modules or nodes that are also connected to the serial bus. For example, a packet of information with the RFID for a key being inserted into the lock cylinder 116 can be transmitted from the modular ignition assembly 110 to the serial bus. The vehicle's appropriate controller(s) connected to the serial bus can receive the RFID information packet and determine whether the RFID of the key being inserted into the lock cylinder 116 matches the RFID of the vehicle. In some embodiments, the RFID key codes for the vehicle can be stored remotely from the modular ignition assembly 110 and can be accessed by the vehicle's appropriate controller(s). Similar to the RFID information being provided to the serial bus, a packet of information with RKE signals can be transmitted from the modular ignition assembly 110 to the serial bus. The vehicle's appropriate controller(s) connected to the serial bus can receive the RKE information packet and determine the appropriate response to the RKE signal.

In other embodiments, a controller can be included in the modular ignition assembly 110 in order to locally determine whether the RFID of the key being inserted into the lock cylinder 116 matches the RFID of the vehicle and/or in order to locally process and respond to the RKE signals. In these embodiments, RFID codes for the vehicle can be stored in the modular ignition assembly 110. In addition, administrative functions for the RFID and/or RKE functions can be performed locally in the modular ignition assembly 110, rather than being performed remotely by the vehicle's appropriate controller(s). Such administrative functions can include, for example, learning codes for new keys and erasing old keys.

In some embodiments, the modular ignition assembly 110 can provide a signal to the serial bus in order to remotely actuate a relay connected to the vehicle's starter. The relay can be located away from the steering column, i.e., not within the modular ignition assembly 110. In these embodiments, although the relay will be connected to high current contacts for the vehicle's starter, the high current contacts are not located within the modular ignition assembly 110. As a result, the high current contacts cannot be accessed through the steering column in order to be hot-wired. In this manner, the modular ignition assembly 110 being connected to a serial bus can provide additional security protections against vehicle theft.

Information can also be provided from other electronic modules within the vehicle to the modular ignition assembly 110 via the serial bus. For example, the vehicle's instrument panel controller can provide information to the serial bus regarding whether the vehicle is in park or an appropriate setting for the brightness of a lock light ring (if included on the lock cylinder 116). The modular ignition assembly 110 can poll the serial bus for packets including this type of information.

In some embodiments, the modular ignition assembly 110, along with any other electronic modules connected to the serial bus, can be assigned a distinct address that can be used to direct certain types of information to certain electronic modules. The information can be transmitted via the serial bus, but the information will be directed to the distinct address of a specific electronic module. For example, information from the modular ignition assembly 110 can be transmitted to a distinct address for the appropriate controller.

As shown in FIGS. 7 and 8, the modular ignition assembly 110 can be easily networked with other components (e.g., vehicle lock electronics systems, vehicle accessory electronics systems, and the like) in the vehicle via a connector 146 on the circuit board 144. These components can communicate with each other or with one or more modules in a variety of ways. In this regard, various forms of vehicle communication systems can be used, including wired networks or busses operating under any of several conventional architectures. A vehicle network or serial bus can use various bus architectures including a Local Interconnect Network (LIN), a Controlled Area Network (CAN), a J1850, or any other vehicle network architecture. These architectures represent only some of the many architectures available and that can be used, all of which fall within the spirit and scope of the present invention. In some embodiments, the modular ignition assembly 110 can communicate with various publicly available or proprietary networks.

In some embodiments, no multiplexing is used. In other embodiments, automotive electrical data communicated between the various electronic modules and electromechanical components of the vehicle (including the modular ignition assemblies described herein) can be multiplexed onto one or more communication busses enabled by terminal connections on the circuit board 144. For a CAN bus, multiplexing exists as a peer to the vehicle's other modules. By using a CAN bus, the number of discrete wires to and from vehicle system components (including the modular ignition assemblies) can be reduced. A CAN bus can provide significant flexibility for system change, can enable inter-platform applications, and can provide for easily-executable content changes. For example, in some embodiments, a module can be added to a vehicle's electronics communication system by plugging a new module into the CAN bus and modifying the software in those modules needing to communicate with the new module, thereby essentially making new electronic modules and electromechanical components (including the ignition module assemblies) “plug and play.” Since the modules or nodes can share a common bus structure, adding a new node need not change the wiring content of the system.

Referring to FIGS. 7 and 8, one or more microcontrollers (e.g., microcontroller chips) are connected to the various components of the modular ignition assembly 110 (e.g., the RKE transceiver 159, the RFID transceiver 152, the ignition switch 124, and the like). In some embodiments, a single microcontroller is used on the circuit board, in which case this single microcontroller can operate several modular systems. In other embodiments, however, each system (i.e., RKE, RFID, and the like) can have its own microcontroller. Microcontrollers enable control of the functions performed by these modular ignition assembly components through a connection to a serial bus or vehicle network.

Some embodiments of the modular ignition assembly can use the Local Interconnect Network (LIN) protocol. As is well known to those skilled in the art, a LIN is a relatively low cost serial communications system used for linking electronic nodes or modules in vehicles and can complement an existing portfolio of automotive multiplexing networks in a vehicle. Accordingly, a LIN can be a sub-bus system of another network. A LIN uses a single master and multiple slave model with only the master being able to initiate a communication, except where the network is asleep. Access in a LIN is controlled by a master node so that no arbitration or collision management is required.

For a LIN bus, each vehicle electronic module or electromechanical device (e.g., the modular ignition assembly 110 connected to the master node via a serial bus or vehicle network is a slave node. Additional modules or nodes can be added to the LIN without requiring hardware or software changes in other slave nodes, if new messages are not delivered. A typical LIN node includes a microcontroller for handling control and the LIN protocol and a LIN transceiver for interfacing with a physical layer (e.g., wires). Accordingly, in those embodiments in which the modular ignition assembly 110 is connected to a LIN, the modular ignition assembly 110 (e.g., the circuit board 144) can include at least one microcontroller and a LIN transceiver.

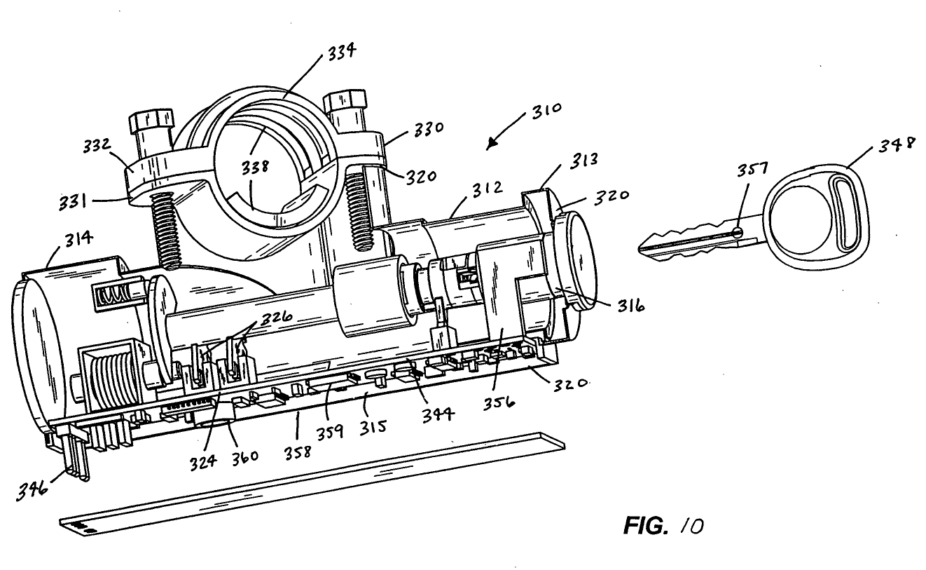

FIG. 9 illustrates a modular ignition assembly 210 according to another embodiment of the invention. Elements and features of the embodiment shown in FIG. 9 that correspond to elements and features of the embodiment of FIGS. 1-8 are designated hereinafter in the 200 series of reference numbers.

The modular ignition assembly 210 includes a housing 212 that receives a lock cylinder 216, a steering column collar 230, and a circuit board 244 having a RFID transceiver 252, a RKE transceiver 259, an ignition switch 224 and various other components.

The lock cylinder 216 of the modular ignition assembly 210 shown in FIG. 9 is a tumblerless lock cylinder and the RFID system 250 controls the security aspects of ignition in the modular ignition assembly 210. Thus, a key does not need to have a mechanically coded surface for the tumblerless lock cylinder 216. Rather, the key can have any shape that mates with the lock cylinder 216, and need not have a conventional cross sectional shape. In some embodiments, the key can be a token, card, or other member containing an RFID transponder 252 that is pressed against or held adjacent the ignition housing 212. In other embodiments, the key can communicate with the RFID transceiver without contacting the ignition housing 212. The key can include a fob in a user's pocket or purse.

In some embodiments, the lock cylinder 216 can have an interlock mechanism to at least hold the key in place and to keep the key retained within the lock cylinder 216. This interlock mechanism can be a magnet positioned with respect to the key slot 217 of the lock cylinder 216 to attract the key in position in the key slot 217, can be a mechanical member (e.g., spring-biased plate, rod, pin, or other element positioned to retain the key in the key slot 217), can be an electromechanical device (e.g., a solenoid or motor-driven plate, rod, pin, or other element) or can take any form of interlock desired. In some embodiments, this interlock mechanism can also prevent key rotation or any other key movement used to activate one or more vehicle elements and systems described herein. By way of example only, the interlock mechanism can extend a pin, bar, or other member toward the key or lock cylinder 216 to selectively interfere with the rotation of the key and/or lock cylinder 216, can selectively activate a clamp acting upon the lock cylinder 216 to control the ability to rotate the lock cylinder 216, and the like. The interlock mechanism can provide a mechanical level of security to the modular ignition assembly 210 in addition to the electronic security level described above.

Although many conventional materials can be used to construct the lock cylinder 216, some embodiments of the present invention use a plastic or composite lock cylinder 216. The use of a plastic lock cylinder 216 can reduce cost and weight associated with the modular ignition lock 110.

The steering column lock 234 used in the modular ignition assembly 210 is a magnetic steering column lock. In some embodiments, the steering column lock 234 can use the magnetism of one or more magnets to retain the steering column shaft in a desired position. As illustrated in FIG. 9, one or more magnets 238 can be placed within the collar 230 in positions adjacent the steering column shaft. By way of example only, the magnets 238 illustrated in FIG. 9 are two curved plate-shaped elements positioned to surround a substantial portion of the steering column shaft. In other embodiments, more or fewer magnets 238 can be positioned within the collar 230 and/or in other locations on the collar 230, and can have different shapes and sizes.

Power can be selectively supplied to a coil to alter the polarity and strength of the magnets 238. In one state, the force of the magnet(s) 238 causes an attraction between the magnets 238 and the steering column shaft. This attraction can be generated in various manners. For example, one or more magnets can be located on the steering column shaft and can have an opposite polarity with respect to the magnets 238. As another example, ferrous material on the steering column shaft (e.g., portions of a sleeve on the steering column shaft comprising ferrous material, one or more ferrous material elements attached or otherwise fixed in place with respect to the steering column shaft in any suitable manner, and the like) can be attracted to the magnets 238. As yet another example, one or more portions of the steering column shaft can comprise ferrous material at the location of the collar 230, and can be attracted to the magnets 238. In any case, the attraction generated by the force of the magnets 238 creates sufficient force to prevent or at least inhibit rotation of the steering column shaft, thereby disabling the vehicle.

To operate the vehicle, the attraction between the steering column shaft and the magnet(s) 238 is reduced or eliminated. In some embodiments, this attraction is reduced or entirely eliminated by demagnetizing the magnet(s) 238, and can be achieved in several different ways. For example, the magnet(s) 238 can be reduced by temporarily supplying current to the coil in a direction opposite the magnetizing pulse for each magnet 238. Depending upon the type of magnet, the pulse or flow of current through the coil in the opposite direction will cause the polarity of the magnet 238 to switch or be reduced to zero based on current flow.

Assuming the magnet(s) 238 of the illustrated embodiment are in the locked and attracted state, the strength of the magnet(s) 238, as discussed above, can be reduced or substantially eliminated to remove the force restraining the steering column shaft. The power required to alter the magnetic polarity can be supplied in response to the rotation, withdrawal, or insertion of an authorized key with respect to the lock cylinder 216 of the modular ignition assembly 210. For example, when the key is rotated in the opposite direction (i.e., to the OFF position) or removed from the lock cylinder 216, power can be supplied in the other direction to magnetize the magnet(s) 238 and cause the magnet(s) 238 to attract to and lock the steering column shaft.

Rather than the magnetic steering column lock 234 being mounted to the ignition housing 212, the magnetic steering column lock 234 can be in a remote location with respect to the modular ignition assembly 210, or can be used without the modular ignition assembly 210. In some embodiments, the magnets can be located on the steering column shaft for interaction with ferrous material located adjacent the steering column shaft (such as on the collar 230, a frame or other structure located adjacent the steering column, and the like). In still other embodiments, magnets can be located on the steering column shaft as well-as on the collar 230 for generating magnetic attraction between the magnets by the selective supply and removal of power to the magnets. In other embodiments, radially-extending magnets or radially-extending elements responsive to magnets can be used to lock the steering column shaft. In still other embodiments, a disc-type brake and caliper construction can be used to lock the steering column shaft. In addition, the magnetic steering column lock 234 can be used in any of the modular ignition assemblies 10, 110, and 210.

As described above, the magnets 238 used to lock and unlock the steering column shaft can be controlled by changing the polarity or strength of the magnets 238, such as by reversing the polarity of the magnets 238 by temporarily exposing the magnets 238 with a directional electrical field or current. In such cases, the magnetism of the magnets 238 in the locked state is sufficient to disable the vehicle by preventing or substantially limiting rotation of the steering column. In other embodiments, the magnets 238 can be electromagnets that provide a sufficient magnetic force to perform the rotation-limiting function when supplied with electrical power. In still other embodiments, the magnets 238 can provide a sufficient force to perform the rotation-limiting function when no electrical power is supplied.

The modular ignition housing 212 can be constructed of any material as described above with respect to the modular ignition assemblies 10 and 110. In some embodiments, the housing 212 is made at least partially or entirely from plastic. Plastics have not typically been used for ignition housings due to the forces that can be exerted on the housing by the lock bolt (e.g., during an attempted theft of the vehicle, when the lock bolt is stressed by force exerted upon the steering column, and the like). If the housing fails, the steering column lock is also subject to failure. Therefore, metal has been used in convention ignition housings for its strength. However, by using a magnetic steering column lock 234 as described above, the forces that may be exerted upon the modular ignition housing 212 are less likely to be damaging. Specifically, the force of the magnets 238 does not necessarily have to prevent all movement of the steering column shaft. Instead, the magnetic force needs only to inhibit such movement to a degree necessary to disable the vehicle. Accordingly, the amount of force experienced by the modular ignition housing 212 can be significantly less than if no movement of the steering column shaft was permitted (such as is typically the case in lock bolt-type steering column locks). Also, the use of a magnetic steering column lock 234 permits the restraining force upon the steering column shaft to be distributed more evenly around the steering column shaft, and therefore more evenly to the modular ignition housing 212. The modular ignition housing 212 is therefore better able to withstand forces exerted upon the steering column shaft (and upon the modular ignition housing 212).

With the exception of the use of a magnetic steering column lock 234 and a tumblerless lock cylinder 216 as described above, the operation of the modular ignition assembly 210 illustrated in FIG. 9 is substantially the same as the modular ignition assemblies 10 and 110. With regard to the magnetic steering column lock 234, if an unlock signal is received from the transponder or tag, power is supplied to the magnet(s) 238 to change the polarity of the magnet(s) 238 and unlock the steering column shaft. However, if an unlock signal is not received from the transponder or tag, no power is supplied to change the polarity of the magnet(s) 238, and the steering column shaft remains locked.

Furthermore, if an unlock signal is received from the transponder or tag, a key can be actuated to cause the ignition to be activated. In some embodiments, a conventional mechanical ignition switch can be used. In such embodiments, the key can be rotated to start the engine. In other embodiments, however, a solid state ignition switch 224 can be used.

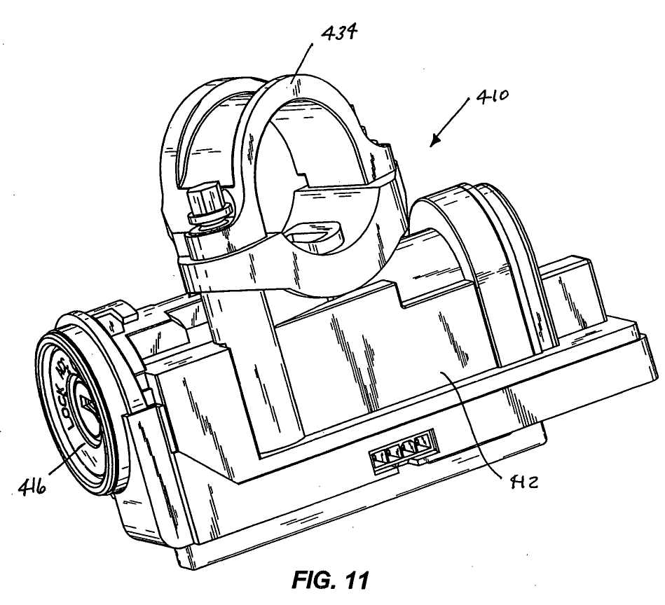

FIG. 10 illustrates a modular ignition assembly 310 according to another embodiment of the invention. Elements and features of the embodiment shown in FIG. 10 that correspond to elements and features of the embodiment of FIGS. 1-9 are designated hereinafter in the 300 series of reference numbers.

The modular ignition assembly 310 can include a housing 312, a steering column lock 334, a circuit board 344 coupled to the housing 312, and a lock cylinder 316 coupled to the housing 312. Rather than using a RFID system, the modular ignition assembly 310 illustrated in FIG. 10 uses a laser reader 356 to determine whether an authorized key is in the modular ignition assembly 310. The laser reader 356 can be coupled to the circuit board 344 and positioned adjacent the lock cylinder 316. The lock cylinder 316 can have an aperture that allows a laser generated by the laser reader 356 to read a coded element 357 of a key 348 once inserted into the lock cylinder 316. The key 348 has a laser-readable identification code. In some embodiments, a laser-readable coded element (e.g., a laser-readable disk or other structure) is inserted into or is otherwise attached to key 348. As the key 348 is inserted into the lock cylinder 316, the coded element 357 passes by the laser reader 356 and/or rests in a line of sight of the laser reader 356 to be read and identified. If the laser reader 356 detects that an authorized key 348 has been inserted into the lock cylinder 316, one or more components of the modular ignition assembly 310 are enabled. If, however, the laser reader 356 detects an unauthorized key, such components will remain disabled (or will be disabled if not already disabled).

The lock cylinder 316 of the modular ignition assembly 310 can be equipped with one or more tumblers to provide additional security. However, in some embodiments, a tumblerless lock cylinder is used.

With the exception of the use of a laser reading system rather than a RFID system, the operation of the modular ignition assembly 310 illustrated in FIG. 10 is substantially the same as the modular ignition assemblies 10, 110 and 210. With regard to the laser reading system of the modular ignition assembly 310, a user places a key 348 having a coded element 357 into the lock cylinder 316. As the key 348 enters the lock cylinder 316 or while the key 348 rests in the lock cylinder 316, the laser reader 356 reads the coded element 357 on the key 348. If the coded element 357 on the key 348 is authorized, the vehicle is operable. If, however, the coded identifier on the key 348 is unauthorized, the vehicle remains inoperable.

The modular ignition assembly 310 includes a magnetic steering column lock 334 with residual magnetism. If the coded element 357 read by the laser reader 356 is for an authorized key, power is supplied to the magnetic steering column lock 334 to change or alter the polarity of the magnets 338 and unlock the steering column. However, if the coded element 357 is not for an authorized key, power is not supplied to the magnetic steering column lock 334. Thus, the polarity of the magnets 338 does not change, and the steering column shaft remains locked. It should be noted that a conventional steering column lock can instead be used in conjunction with the laser reader 356.

The modular ignition assembly 310 can also include a solid state ignition switch 324. If the coded element 357 read by the laser reader 356 is for an authorized key, the key 348 can be actuated to cause the modular ignition assembly 310 to activate one or more components of the vehicle. Alternatively, the modular ignition assembly 310 can be equipped with a conventional mechanical ignition switch which can be responsive to turning or other actuation of the key 348.

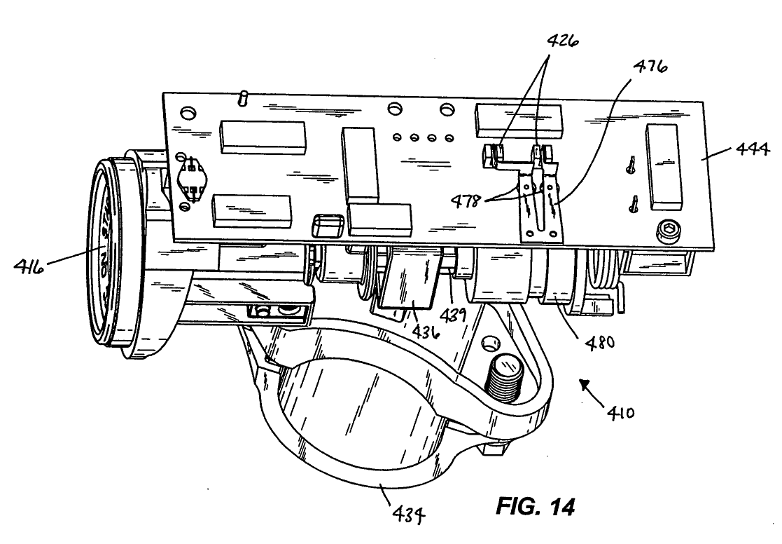

FIGS. 11-14 illustrate a modular ignition assembly 410 according to another embodiment of the invention. Elements and features of the embodiment shown in FIGS. 11-14 that correspond to elements and features of the embodiments of FIGS. 1-10 are designated hereinafter in the 400 series of reference numbers.

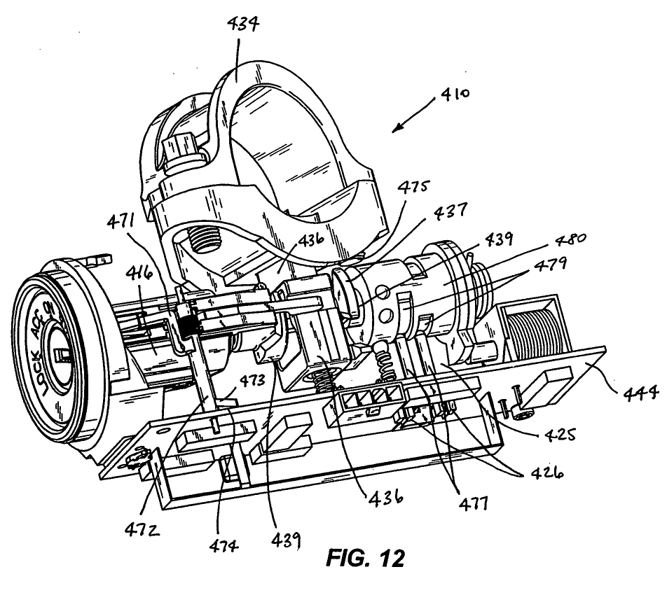

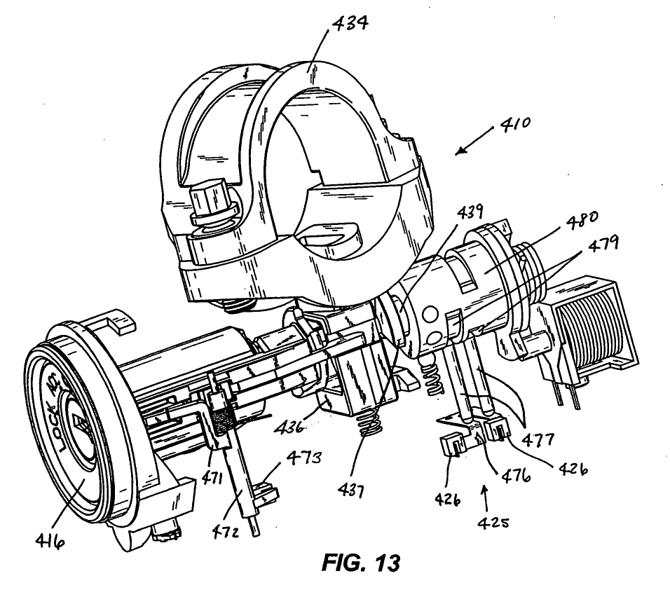

The modular ignition assembly 410 can include a housing 412, a steering column lock 434, a circuit board 444 coupled to the housing 412, and a lock cylinder 416 coupled to the housing 412. The modular ignition assembly 410 has one or more sensors for detecting the presence of a key in the lock cylinder 416. By way of example only, a lever 471 can be positioned to be responsive to insertion of a key into the lock cylinder 416, and can move to rotate a pivot 472 to which the lever 471 is coupled. The pivot 472 can be secured in any manner in the housing 412, such as in apertures in the housing 412 and/or in the circuit board 444. As best shown in FIGS. 12 and 13, a foot 473 on the pivot 472 is movable by the pivot 472 to actuate a key minder switch 474 mounted on the circuit board 444. The key minder switch 474 can be directly or indirectly electrically coupled to the RFID transceiver in order to trigger interrogation of the key by the RFID electronics. In this manner, when a key is inserted into the key cylinder 416, the lever 471 actuates the pivot 472 about its axis, thereby actuating the key minder switch 474. It will be appreciated that the key minder switch 474 can be actuated in a number of other manners and by other structures coupled to the key cylinder 416, such as a cam on the key cylinder 416 rotatable to selectively actuate the key minder switch 474, a pin, post, or other projection extending radially from the key cylinder 416 and actuatable by a key inserted therein to actuate the key minder switch 474, and the like. Still other key minder switch actuation elements and devices are possible, and fall within the spirit and scope of the present invention.

The modular ignition assembly 410 can also include a lock bolt-type steering column lock 434. The structure and operation of the steering column lock 434 is substantially the same as that described above with reference to the modular ignition assembly 10. However, a cam 437 can be used to actuate the lock bolt 436. The cam 437 can be located on the pivot 439 to actuate a projection 475 on a side of a lock bolt 436 (rather than an inside surface of an aperture in the lock bolt 436). The cam 437 can have any suitable shape and as shown in FIGS. 11-14 can be generally sector shaped. The projection 475 can also have any shape capable of being actuated by the cam 437.

The modular ignition assembly 410 can use solid state electronics to determine the position of the key cylinder 416. The modular ignition assembly 410 can include an encoder assembly 425. The encoder assembly 425 can include photo interrupters 426, a leaf spring 476, and pins 477. As shown in FIGS. 11-14, portions of a leaf spring 476 mounted on the circuit board 444 are movable with respect to photo interrupters 426 to selectively interrupt light beams emitted by the LEDs of the photo interrupters 426. Although a single leaf spring 476 having different leaves is shown in FIGS. 11-14, multiple leaf springs can be used in other embodiments (e.g., a dedicated leaf spring for each photo interrupter 126).

As shown in FIGS. 11-14, the leaves of the leaf spring 476 are moved by pins 477. The pins 477 can extend through apertures 478 in the circuit board 444 for actuating the leaf spring 476. In other embodiments, the pins 477 do not extend through apertures 478 in the circuit board 444 (such as in cases where the photo interrupters 426 and the leaf springs 476 are on the opposite side of the circuit board 444 shown in FIGS. 11-14). In some embodiments, the photo interrupters 426 can be substantially enclosed in a protective electronics enclosure of the modular ignition assembly 410.

The pins 477 can be actuated by riding upon cam surfaces 479 of a cam 480 driven by the pivot 439. The cam surfaces 479 can have any shape capable of driving the pins 477 to different positions. As shown in FIGS. 11-14, the cam surfaces 479 can have varying radii at different circumferential positions about the cam 480, thereby causing the pins 477 to move radially with respect to the cam 480 as the cam 480 rotates. The cam surfaces 479 can be located within grooves of the cam 480 as shown in FIGS. 11-14, or can be on any other surfaces of the cam 480.

The encoder assembly 425 can be used to detect four different states of the lock cylinder 416, although fewer or additional states can be detected by using a single photo interrupter 426 or by using one or more additional photo interrupters 426 and corresponding spring portions, respectively. In other embodiments, a quadrature-type encoder assemblies can be used. In such cases, the relative positions of the leaf spring 476 with respect to the photo interrupters 426 can be changed so that the different portions of the leaf spring 476 interrupting the light beams of the photo interrupters 426 are moved through or past the photo interrupters 426. These portions of the leaf spring 476 can have any number of apertures to interrupt the light beams at different positions of the leaf spring portions with respect to the photo interrupters 426. For example, the leaf spring 476 can have apertured portions that translate with respect to the photo interrupters 426. A controller can count the number of passing apertures (or non-apertured portions therebetween) to determine the position of each leaf spring portion 476, and therefore the positions of the corresponding pins 477, cam 480, and lock cylinder 416. Any number of positions and states of the lock cylinder 416 and modular ignition assembly 410 can be detected by the encoder assembly 425.

In other embodiments, the light beams of the photo interrupters 426 can be interrupted by any other element or structure desired. Such elements or structures can include the tips of pins 477 extending toward the photo interrupters 426, levers movable by the pins 477 and with respect to the photo interrupters 426, and the like. Also, although pins 477 are used to actuate the portions of the leaf spring 476, any number and variety of other elements can instead be actuated by the cam 480 to perform this function. For example, the cam 480 can actuate levers about a pivot secured with respect to the cam 480.

As described in the various embodiments above and illustrated in the figures, a number of different devices can be used to verify whether a key is one that is authorized to operate the vehicle. Such devices include a lock cylinder that mechanically reads a coded surface of a key, a RFID system in which one or more signals are transmitted from the key to the modular ignition assembly to authenticate the key, a laser reader reading a coded surface on a key, and the like. In some embodiments, only one of these devices is used in the authentication process, while in other embodiments, more than one of these devices is used. These devices read a key in different ways (e.g., mechanically, electrically, and optically), and represent only a few examples of how a key can be read for authentication. Other key reading devices exist, and can be used in any of the modular ignition systems described herein and/or illustrated in the accompanying figures. For example, the modular ignition assembly can use a bar-code reader for reading a bar-coded surface of a key, a key reader receiving signals from the key by infrared, microwave, ultraviolet, or other frequency transmission, via a suitable transmitter, transceiver, or responder of the key and a suitable receiver or transceiver at the modular ignition assembly, and the like. Accordingly, the term “key” as used herein and in the appended claims refers to any portable device carried by a user and carrying a code used by the key reader to authenticate the portable device. For example, the term “key” includes any type of coded key surface mechanically read by the key reader (e.g., as described above with reference to the lock cylinders, a key instead or additionally having any other type of coded surface read mechanically, optically, electronically, magnetically, or in any other manner (e.g., read optically, a bar-coded surface, and the like), a key instead or additionally capable of sending one or more authorization signals to the modular ignition assembly by electrical connection or wireless transmission thereto, and the like.

The term “key reader” as used herein and in the appended claims refers to the elements or structure used by the modular ignition assembly to read a key, whether mechanically, electrically, optically, magnetically, or in any other manner as described above. Accordingly, the key reader need not necessarily mechanically or electrically connect to a key. In the embodiments illustrated in the figures, the key reader (e.g., lock cylinder and RFID electronics of the modular ignition assembly, tumblerless lock cylinder with RFID electronics of the modular ignition assembly, and tumblerless lock cylinder with laser reader) receives a blade of a key. However, in other embodiments the key reader can be mechanically and releasably coupled to any type of key in any manner, such as by removably receiving part or all of the key, by any mechanical connection between the key and the key reader, by inter-engaging elements of the key and key reader, and the like. In some embodiments, the key reader can also be releasably electrically coupled to a key in any such manner. Also, in some embodiments, the key reader and key need not be or are not adapted to be physically coupled—whether mechanically or electrically. In such cases, the key reading function can be performed entirely wirelessly.

The embodiments described above and illustrated in the figures are presented by way of example only and are not intended as a limitation upon the concepts and principles of the present invention. Accordingly, it will be appreciated by one having ordinary skill in the art that various changes in the elements and their configuration and arrangement are possible without departing from the spirit and scope of the present invention. For example, various alternatives to the features and elements of the modular ignition assemblies are described with reference to each modular ignition assembly. With the exception of features, elements, and manners of operation that are mutually exclusive of or are inconsistent with each illustrated embodiment described above, it should be noted that the alternative features, elements, and manners of operation described with reference to each of the modular ignition assemblies are applicable to the other embodiments.

1. A modular ignition assembly for a vehicle having at least one door and at least one system operable by a key, the modular ignition assembly comprising:
a housing;
a key reader located at least partially within the housing, the key reader comprising
an antenna;
an RFID receiver coupled to the antenna and adapted to receive RFID signals from the key via the antenna, the RFID signals comprising a code used for authorizing operation of at least one system of the vehicle;
a processor coupled to the key reader to receive signals from the key reader responsive to RFID signals received by the RFID receiver; and
an RKE receiver located within the housing and adapted to receive RKE signals transmitted to the modular ignition assembly to unlock at least one door of the vehicle;
wherein the housing, key reader, antenna, and RFID receiver comprise an assembly configured for mounting in a vehicle as a single integral unit.

2. The modular ignition assembly as claimed in claim 1, wherein the antenna is coupled to the RKE receiver to receive RKE signals.

3. The modular ignition assembly as claimed in claim 1, wherein the antenna is a first antenna, the modular ignition assembly further comprising a second antenna coupled to the RKE receiver to receive RKE signals from a remote source.

4. The modular ignition assembly as claimed in claim 1, wherein the RKE receiver is adapted to receive RKE signals transmitted to the modular ignition assembly from a fob.

5. The modular ignition assembly as claimed in claim 1, wherein the key reader, antenna, and processor are located at least partially within the housing.

6. The modular ignition assembly as claimed in claim 5, wherein the key reader, antenna, and processor are located on a common circuit board.

7. The modular ignition assembly as claimed in claim 5, wherein the key reader, antenna, and processor are located within a common electronics enclosure of the vehicle access module.

8. The modular ignition assembly as claimed in claim 1, wherein the antenna and RFID receiver are located on a common circuit board.

9. The modular ignition assembly as claimed in claim 8, wherein the RKE receiver is also located on the common circuit board.

10. The modular ignition assembly as claimed in claim 8, wherein the process is also located on the common circuit board.

11. The modular ignition assembly as claimed in claim 1, wherein the antenna is at least partially located in a wall of the housing.

12. The modular ignition assembly as claimed in claim 1, further comprising a lock cylinder located at least partially within the housing and shaped to removably receive a part of the key therein.

13. The modular ignition assembly as claimed in claim 1, wherein the lock cylinder has a plurality of tumblers releasably engageable with a coded surface of the key.

14. The modular ignition assembly as claimed in claim 1, wherein the RFID receiver is part of an RFID transceiver coupled to the antenna and configured for two-way communication with a receiver of the key.

15. The modular ignition assembly as claimed in claim 1, wherein the RKE receiver is part of an RKE transceiver, and communicates with a source of the RKE signals.

16. The modular ignition assembly as claimed in claim 1, further comprising a tire pressure monitor circuit located at least partially within the housing and adapted to receive signals representative of tire pressure of at least one vehicle tire.

17. The modular ignition assembly as claimed in claim 1, further comprising a remote starter circuit located at least partially within the housing and adapted to receive at least one wireless signal representative of a command to start the vehicle.

18. The modular ignition assembly as claimed in claim 1, further comprising a window control circuit located at least partially within the housing and adapted to receive at least one signal representative of a command to move at least one vehicle window.

19. The modular ignition assembly as claimed in claim 1, further comprising:
an ignition switch; and
a lock located at least partially within the housing and actuatable to prevent the ignition switch from being placed in at least one state.

20. The modular ignition assembly as claimed in claim 1, further comprising a steering column lock having a lock bolt received at least partially within the housing in a position of the lock bolt.

21. A method of assembling a vehicle ignition and access assembly operable by a key, the method comprising:
providing a housing;
coupling an antenna to an RFID receiver, the RFID receiver adapted to receive RFID signals from the key via the antenna, the RFID signals comprising a code used for authorizing operation of at least one system of the vehicle;
installing a key reader at least partially within the housing, the key reader comprising the antenna and the RFID receiver;
coupling the RFID receiver to a processor adapted to receive signals from the key reader responsive to RFID signals received by the RFID receiver; and
installing an RKE receiver in the housing;
wherein the housing, key reader, antenna, and RFID receiver comprise an assembly configured for mounting in a vehicle as a single integral unit.

22. The method claimed in claim 21, wherein installing the key reader includes inserting the key reader at least partially into the housing.

23. The method claimed in claim 21, wherein installing the key reader includes molding at least part of the antenna into the housing.

24. The method claimed in claim 21, further comprising coupling the antenna to the RKE receiver to receive RKE signals.

25. The method claimed in claim 21, further comprising coupling another antenna to the RKE receiver to receive RKE signals.

26. The method claimed in claim 21, wherein the RKE receiver is adapted to receive RKE signals transmitted to the modular ignition assembly from a fob.

27. The method claimed in claim 21, further comprising installing the processor within the housing, wherein the housing, key reader, antenna, RFID receiver, and processor comprise an assembly configured for mounting in a vehicle as a single integral unit.

28. The method claimed in claim 27, wherein the RFID receiver, the antenna, and the processor are mounted on a common circuit board.

30. The method claimed in claim 27, wherein the RFID receiver, the antenna, and the processor are located within a common electronics enclosure of the vehicle ignition and access assembly.

31. The method claimed in claim 21, wherein the antenna and RFID receiver are mounted on a common circuit board, the method further comprising inserting the common circuit board at least partially into the housing.

32. The method claimed in claim 31, wherein the RKE receiver is also mounted on the common circuit board.

33. The method claimed in claim 31, wherein the processor is also mounted on the common circuit board.

34. The method claimed in claim 21, further comprising molding the antenna at least partially within the housing.

35. The method claimed in claim 21, further comprising inserting at least part of a cylinder lock within the housing, the cylinder lock shaped to receive a portion of the key.

36. The method claimed in claim 35, wherein the lock as a plurality of tumblers releasably engageable with a coded surface of the key.

37. The method claimed in claim 21, wherein the RFID receiver is part of an RFID transceiver coupled to the antenna and configured for two-way communication with a receiver of the key.

38. The method claimed in claim 21, wherein the RKE receiver is part of an RKE transceiver configured for two-way communication with a source of RKE signals.

39. The method claimed in claim 21, further comprising installing a tire pressure monitor circuit at least partially within the housing and adapted to receive signals representative of tire pressure of at least one vehicle tire.

40. The method claimed in claim 21, further comprising installing a remote starter circuit at least partially within the housing and adapted to receive at least one wireless signal representative of a command to start the vehicle.

41. The method claimed in claim 21, further comprising installing a window control circuit at least partially within the housing and adapted to receive at least one signal representative of a command to move at least one vehicle window.

42. The method claimed in claim 21, further comprising:
coupling an ignition switch to the housing; and
coupling a lock to the housing, the lock actuatable to prevent the ignition switch from being placed in at least one state.

43. The method claimed in claim 21, further comprising coupling a steering column lock to the housing.

44. A modular ignition assembly for a vehicle having at least one door and at least one system operable by a key, the modular ignition assembly comprising:
a circuit board;
a key reader coupled to the circuit board, the key reader comprising
an antenna;
an RFID receiver coupled to the antenna and adapted to receive RFID signals from the key via the antenna, the RFID signals comprising a code used for authorizing operation of at least one system of the vehicle;
a processor coupled to the key reader to receive signals from the key reader responsive to RFID signals received by the RFID receiver; and
an RKE receiver coupled to the circuit board and adapted to receive RKE signals transmitted to the modular ignition assembly to unlock at least one door of the vehicle;
wherein the circuit board, key reader, antenna, and RFID receiver comprise an assembly configured for mounting in a vehicle as a single integral unit.

45. The modular ignition assembly claimed in claim 44, wherein the antenna and RFID receiver are mounted upon the circuit board.

46. The modular ignition assembly claimed in claim 45, wherein the processor is mounted upon the circuit board.

47. The modular ignition assembly claimed in claim 45, wherein the RKE receiver is mounted upon the circuit board.

48. The modular ignition assembly claimed in claim 44, wherein the processor is mounted upon the circuit board.

49. The modular ignition assembly claimed in claim 48, wherein the RKE receiver is mounted upon the circuit board.

50. The modular ignition assembly claimed in claim 44, wherein the antenna is coupled to the RKE receiver to receive RKE signals.

51. The modular ignition assembly as claimed in claim 44, wherein the antenna is a first antenna, the modular ignition assembly further comprising a second antenna coupled to the RKE receiver to receive RKE signals from a remote source.

52. The modular ignition assembly as claimed in claim 44, wherein the RKE receiver is adapted to receive RKE signals transmitted to the modular ignition assembly from a fob.

53. The modular ignition assembly as claimed in claim 44, further comprising a housing within which each of the key reader, the antenna, and the processor are at least partially received.

54. The modular ignition assembly as claimed in claim 53, wherein the key reader, antenna, and processor are mounted to the circuit board.

55. The modular ignition assembly as claimed in claim 53, wherein the key reader, antenna, and processor are located in an electronics enclosure of the housing.

56. The modular ignition assembly as claimed in claim 44, further comprising a housing within which each of the antenna and the RFID receiver are at least partially received.

57. The modular ignition assembly as claimed in claim 56, wherein the RKE receiver is also located at least partially within the housing.

58. The modular ignition assembly as claimed in claim 56, wherein the processor is also located at least partially within the housing.

59. The modular ignition assembly as claimed in claim 44, wherein the antenna is located at least partially within a wall of the housing.

60. The modular ignition assembly as claimed in claim 44, further comprising a lock cylinder shaped to removably receive a part of the key therein.

61. The modular ignition assembly as claimed in claim 60, wherein the lock cylinder has a plurality of tumblers releasably engageable with a coded surface of the key.

62. The modular ignition assembly as claimed in claim 44, wherein the RFID receiver is part of an RFID transceiver coupled to the antenna and configured for two-way communication with a receiver of the key.

63. The modular ignition assembly as claimed in claim 44, wherein the RKE receiver is part of an RKE transceiver, and communicates with a source of the RKE signals.

64. The modular ignition assembly as claimed in claim 44, further comprising a tire pressure monitor circuit on the circuit board and adapted to receive signals representative of tire pressure of at least one vehicle tire.

65. The modular ignition assembly as claimed in claim 44, further comprising a remote starter circuit located on the circuit board and adapted to receive at least one wireless signal representative of a command to start the vehicle.

66. The modular ignition assembly as claimed in claim 44, further comprising a window control circuit located on the circuit board and adapted to receive at least one signal representative of a command to move at least one vehicle window.

67. The modular ignition assembly as claimed in claim 44, further comprising:
an ignition switch; and
a lock coupled to the circuit board and actuatable to prevent the ignition switch from being placed in at least one state.

68. The modular ignition assembly as claimed in claim 67, further comprising a steering column lock, wherein the circuit board, key reader, antenna, RFID receiver, and the steering column lock comprise an assembly configured for mounting in a vehicle as a single integral unit.

69. A method of assembling a vehicle ignition and access assembly operable by a key, the method comprising:
providing a circuit board;
coupling an antenna to an RFID receiver, the RFID receiver adapted to receive RFID signals from the key via the antenna, the RFID signals comprising a code used for authorizing operation of at least one system of the vehicle;
coupling the antenna and RFID receiver to the circuit board;
coupling the RFID receiver to a processor coupled to the circuit board and adapted to receive signals from the RFID receiver responsive to RFID signals received by the RFID receiver; and
coupling an RKE receiver to the circuit board;
wherein the circuit board, antenna, and RFID receiver comprise an assembly configured for mounting in a vehicle as a single integral unit.

70. The method as claimed in claim 69, further comprising mounting the antenna and RFID receiver upon the circuit board.

71 The method as claimed in claim 70, further comprising mounting the processor upon the circuit board.

72. The method as claimed in claim 70, wherein coupling the RKE receiver to the circuit board comprises mounting the RKE receiver upon the circuit board.

73. The method as claimed in claim 69, further comprising mounting the processor upon the circuit board.

74. The method as claimed in claim 73, wherein coupling the RKE receiver to the circuit board comprises mounting the RKE receiver upon the circuit board.

75. The method as claimed in claim 69, further comprising inserting the antenna within a housing of the vehicle ignition and access assembly.

76. The method as claimed in claim 69, further comprising molding the antenna within a housing of the vehicle ignition and access assembly.

77. The method claimed in claim 69, further comprising coupling the antenna to the RKE receiver to receive RKE signals.

78. The method claimed in claim 69, further comprising coupling another antenna to the RKE receiver to receive RKE signals.

79. The method claimed in claim 69, wherein the RKE receiver is adapted to receive RKE signals transmitted to the vehicle ignition and access assembly from a fob.

80. The method claimed in claim 69, further comprising installing the RFID receiver, the antenna, and the processor in a common housing of the vehicle ignition and access assembly.

81. The method claimed in claim 80, further comprising receiving the RFID receiver, the antenna, and the processor within a common electronics enclosure of the housing.

82. The method claimed in claim 69, further comprising installing the RFID receiver and antenna within a common housing of the vehicle ignition and access assembly.

83. The method claimed in claim 69, further comprising molding the antenna at least partially within a housing of the vehicle ignition and access assembly.

84. The method claimed in claim 69, wherein the RFID receiver is part of an RFID transceiver coupled to the antenna and configured for two-way communication with a receiver of the key.

85. The method claimed in claim 69, wherein the RKE receiver is part of an RKE transceiver configured for two-way communication with a source of RKE signals.

86. The method claimed in claim 69, further comprising coupling a tire pressure monitor circuit to the circuit board, the tire pressure monitor circuit adapted to receive signals representative of tire pressure of at least one vehicle tire.

87. The method claimed in claim 69, further comprising installing a remote starter circuit on the circuit board, the remote starter circuit adapted to receive at least one wireless signal representative of a command to start the vehicle.

88. The method claimed in claim 69, further comprising installing a window control circuit on the circuit board, the window control circuit adapted to receive at least one signal representative of a command to move at least one vehicle window.

89. The method claimed in claim 69, further comprising:
coupling an ignition switch to the circuit board; and
providing a lock actuatable to prevent the ignition switch from being placed in at least one state.
